(19) United States
(12) Patent Application Publication
(10) Pub. No.: US 2022/0261661 A1
(43) Pub. Date: Aug. 18, 2022

(54) METHODS, SYSTEMS, ARTICLES OF MANUFACTURE AND APPARATUS TO IMPROVE JOB SCHEDULING EFFICIENCY

(71) Applicant: Intel Corporation, Santa Clara, CA (US)

(72) Inventors: Ehsan Hosseinzadeh Khaligh, Rocklin, CA (US); Michael Whitney, Folsom, CA (US); Nathaniel Sema, Folsom, CA (US); Kshitij A. Doshi, Tempe, AZ (US)

(21) Appl. No.: 17/625,946

(22) PCT Filed: Aug. 7, 2020
(86) PCT No.: PCT/US2020/045464

§ 371 Date: Jan. 10, 2022

Related U.S. Application Data
(60) Provisional application No. 62/883,747, filed on Aug. 7, 2019.
(60) Provisional application No. 62/947,802, filed on Dec. 13, 2019.

(51) Int. Cl. G06N 5/02; G06Q 10/06

(52) U.S. Cl. CPC G06N 5/022; G06Q 10/06314

(57) ABSTRACT

Methods, apparatus, systems and articles of manufacture to improve job scheduling efficiency are disclosed. An example apparatus includes a feature generator to import default values of features corresponding to a first model type, a label trainer to train labels corresponding to the first model type, and a model evaluator to determine an accuracy metric of the first model type based on a first prediction corresponding to the default features, and update the features from the default values to updated values when the accuracy metric does not satisfy an accuracy threshold.

### RELATED APPLICATIONS

This patent claims the benefit of U.S. Provisional Patent Application No. 62/883,747, which was filed on Aug. 7, 2019, and claims the benefit of U.S. Provisional Patent Application No. 62/947,802, which was filed on Dec. 13, 2019. U.S. Provisional Patent Application No. 62/883,747, and U.S. Provisional Patent Application No. 62/947,802 are hereby incorporated herein by reference in their entireties. Priority to U.S. Provisional Patent Application Nos. 62/883,747 and 62/947,802 are hereby claimed.

### FIELD OF THE DISCLOSURE

This disclosure relates generally to resource consumption management, and, more particularly, to methods, systems, articles of manufacture and apparatus to improve job scheduling efficiency.

### BACKGROUND

In recent years, demand for computing resources has increased. Computing resources include personal computers, servers, server farms and/or cloud-based computing services. Such resources perform tasks based on job descriptions, in which the computing services might bill a client based on a quantity of computing cycles consumed.

### BRIEF DESCRIPTION OF THE DRAWINGS

FIG. 1A is a schematic illustration of an example scheduling system.

FIG. 1B is a schematic illustration of example hardware resources for which predictions are to be made in a manner consistent with examples disclosed herein.

FIG. 2A is a schematic illustration of an improved scheduling system to accept job input information, the improved scheduling system including an example scheduling framework.

FIG. 2B is an alternate schematic illustration of the example scheduling framework.

FIG. 3A is a schematic illustration of additional detail of the scheduling framework of FIGS. 2A and 2B to improve job scheduling efficiency.

FIGS. 3B-3E are tables of example information generated and/or otherwise captured to identify hardware utilization and associated job assignments.

FIG. 4A is a schematic illustration of example machine learning model assignments implemented by the example scheduling framework of FIGS. 2A, 2B and 3A.

FIG. 4B is a flowchart representative of machine readable instructions which may be executed to implement the example machine learning model assignments of FIG. 4A.

FIG. 4C is an alternate schematic illustration of the example scheduling framework.

FIGS. 5A1, 5A2, 5A3, 5B, 6A, 6B, 7, 8A-8E, 9 and 10 are flowcharts representative of machine readable instructions which may be executed to implement the example scheduling framework of FIGS. 2A, 2B, 3A and 4C.

FIG. 11 is a block diagram of an example processing platform structured to execute the instructions of FIGS. 5A1, 5A2, 5B, 6A, 6B, 7, 8A-8E, 9 and 10 to implement the example scheduling framework of FIGS. 2A, 2B, 3A and 4C.

FIG. 12 is a block diagram showing an overview of another configuration for edge computing.

FIG. 13 illustrates operational layers among endpoints, an edge cloud, and cloud computing environments.

FIG. 14 shows requests and responses exchanged between client endpoints.

FIG. 15 illustrates an example deployment and orchestration for virtual edge configurations across an edge computing system operated among multiple edge nodes and multiple tenants.

FIG. 16 illustrates additional compute arrangements deploying containers in an edge computing system.

FIG. 17 shows a simplified vehicle compute and communication use case involving mobile access to applications in an edge computing system that implements an edge cloud.

FIGS. 18A-18B depict example implementations of compute nodes or devices discussed with reference to the edge computing systems and environment disclosed and described herein.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Hardware resources provide results (throughput) to clients that submit jobs to be processed by such hardware resources. To satisfy client demands and improve (e.g., increase) utilization metrics of the hardware resources, the hardware resources must be managed. For instance, hardware resources that have any number of processing units (e.g., individual processors, individual servers, individual cores on respective processors, processing platforms that allocate and/or otherwise manage virtual machines (VMs), CPUs, graphical processing units (GPUs), application specific integrated circuits (ASICs), field programmable gate arrays (FPGAs), etc.) allocate jobs in a manner that satisfies client throughput expectations and prevents any one of those processing units from operating in an overburdened manner. Several industries focus their efforts on resource demand management, such as data centers, cloud service providers and/or edge cloud services. Such industries must meet customer expectations yet manage resources in an efficient manner to conserve costs and energy consumption. In the event jobs are assigned to and/or otherwise distributed to the processing resources in a wasteful manner, then some clients may experience temporally lagged performance when submitting job requests because such processing resources are consumed by other jobs.

Scheduling systems attempt to manage job assignments to available hardware resources. In some examples, the scheduling systems perform statistical analysis on job input requests to identify how to allocate particular jobs (sometimes referred to herein as mapping jobs to resources) to particular resources. Some commercial scheduling systems include Kubernetes®, Docker Platform®, SLURM®, IBM Spectrum®, etc. In some examples, resource fingerprinting assists with best fit matching techniques, such as bin packing, shortest remaining time-based priority techniques, statistical admission control, and deep learning-based prioritization. However, current systems suffer from assumptions of workload consistency and a degree of rigidity in the event those assumptions deviate from expectations. In some examples, even systems that can accommodate any number of different models is problematic because operator discretion dictates which models are applied regardless of their efficacy. However, operator discretion typically fails to properly consider objective rationale when deciding which models to apply and when.

Examples disclosed herein improve resource allocation of jobs based on predicting a total number of idle and available contiguous connected resources in particular user-defined timeframes. Examples disclosed herein apply divide-and-conquer techniques to simplify machine learning operation(s), scheduling, and facilitate responsive adaptation when telemetry behaviors deviate from expectations. Objectives of the scheduling systems include improved resource utilization efficiency, improved throughput and elasticity of scale as workload demands fluctuate. Such objectives allow a reduction in a total cost of ownership for the resources and increased profits. Example constraints managed by the scheduling systems include tail response time management, thermal runaway prevention and adherence to service level agreements (SLAs). In some examples disclosed herein, a total number of idle and contiguous available emulator boards are predicted within a temporal span of one hour. Examples disclosed herein improve (e.g., maximize) a hardware resource utilization metric, reduce an average duration for scheduled jobs in a waiting queue, and improve profits associated with such hardware utilization management. Examples disclosed herein further increase (e.g., maximize) utilization of resources without violating SLA expectations, track allocation effectiveness, and adapt to changing conditions (e.g., circumstances where resource availability fluctuates based on workload job request variation(s)). Examples disclosed herein are not limited to centralized resource pools, such as cloud centers that manage any number of server farms. That is, examples disclosed herein facilitate improved edge network resource utilization such that allocated workloads do not inundate relatively less capable edge-located resources (e.g., Internet of Things (IoT) device(s)).

Additionally, examples disclosed herein allow any amount or variety of models to be applied without inundating and/or depending on operator discretion. Models include, but are not limited to, classic regression models (e.g., polynomial models of adjustable degrees) and neural network models. Examples disclosed herein select models based on, in part, metadata corresponding to job requests, model performance track records and/or model metadata indicative of particular model strengths. Examples disclosed herein permit model training to occur independently of model learning activities (divide and conquer). Examples disclosed herein also select particular models based on an analysis of available historical data. For instance, more modeling effort is spent with relatively higher-degree polynomial models when less is known about jobs/requests, whereas LSTM models are applied when historical job/request data is available, thereby improving system efficiency.

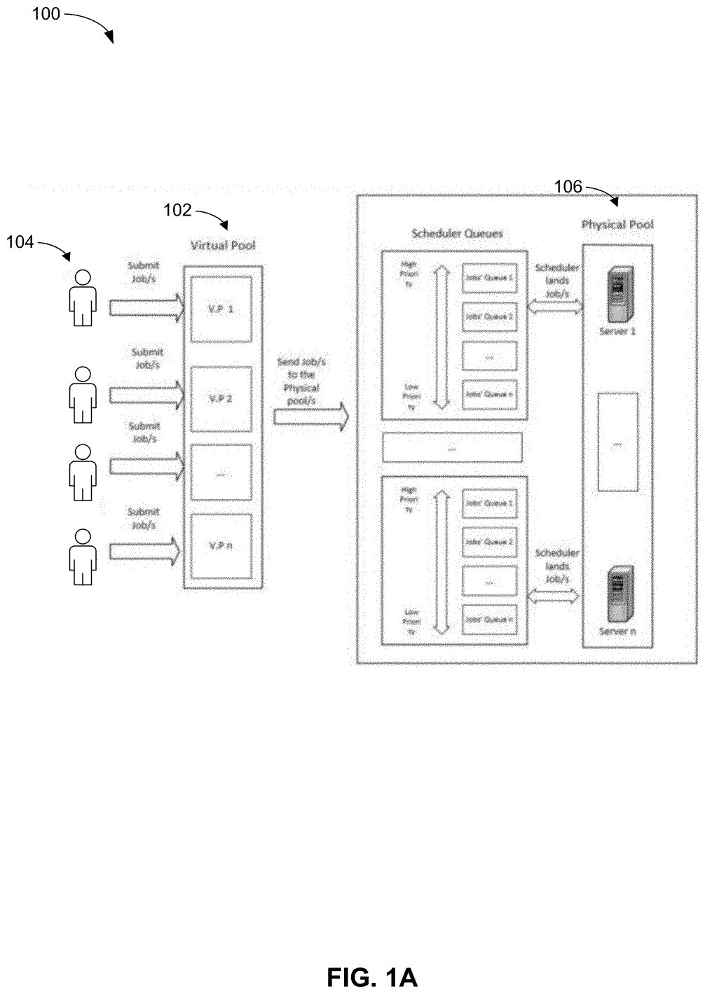

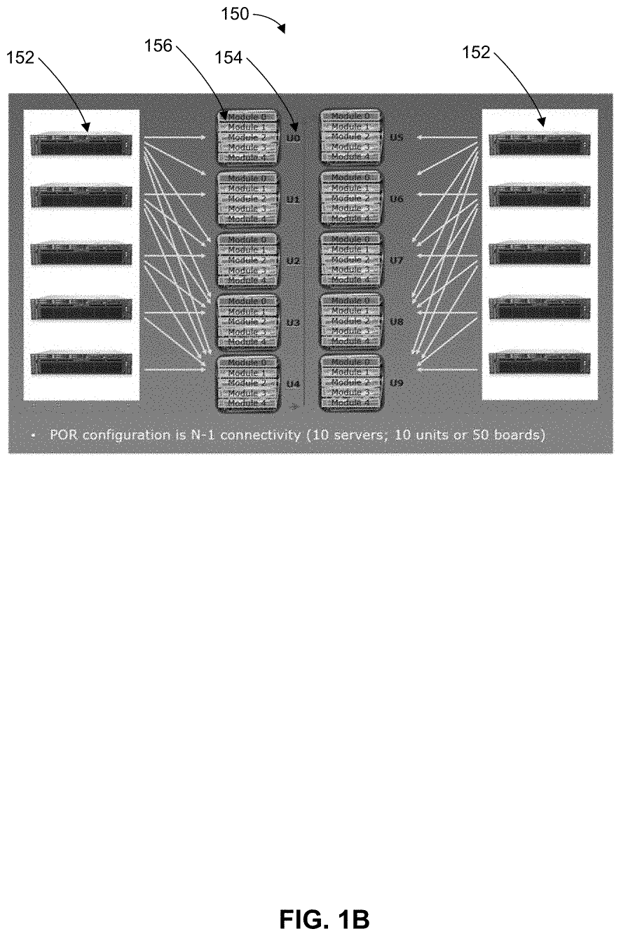

FIG. 1A is a schematic illustration of an example scheduling system 100. In the illustrated example of FIG. 1A, the scheduling system 100 includes a virtual pool 102 facilitated by the scheduling system 100 to accept job input information from any number of users 104. The job input information may include, but is not limited to, job type information, job priority information (e.g., numeric ranking of job importance), required computer processing unit (CPU) resources (e.g., a number of CPU cores, a number of processors, a number of workstations, etc.), required memory resources (e.g., number, type and/or size of memory resources), etc. The example scheduling system 100 of FIG. 1A also includes an example physical pool 106, which includes any number and type of hardware resources to perform the jobs and/or tasks associated with respective jobs.

Traditional and/or otherwise state of the art scheduling systems retrieve requests from requestors (users 104) corresponding to jobs. Such jobs are queued in the example virtual pool 102, which performs screening and sorting tasks. In some examples, a requisite quantity of jobs is accumulated before sending those jobs to physical resources, while in other examples jobs are classified into different virtual pools. In some examples, the different virtual pools 102 are organized according to their specialized hardware needs, such as a need for continuous/connected processor cores, and in some examples the virtual pools 102 are organized according to particular software needs, user-based priorities, project-based priorities, security objectives, etc. Jobs from the virtual pools are then sent to and/or otherwise assigned particular hardware resources of the physical pool 106.

FIG. 1B is a schematic illustration of example hardware resources 150 for which predictions are to be made. In some examples, the hardware resources 150 are referred to as a cluster. In the illustrated example of FIG. 1B, the cluster 150 includes ten (10) servers 152, in which the example servers are emulators. Each example emulator (e.g., server 152) in the illustrated example of FIG. 1B includes one example unit 154, and each unit 154 includes five example boards 156. In some examples, boards are referred to as “modules.” Accordingly, the illustrated example of FIG. 1B includes a big box emulator 150 with 10 units or 50 boards, but examples disclosed herein are not limited thereto.

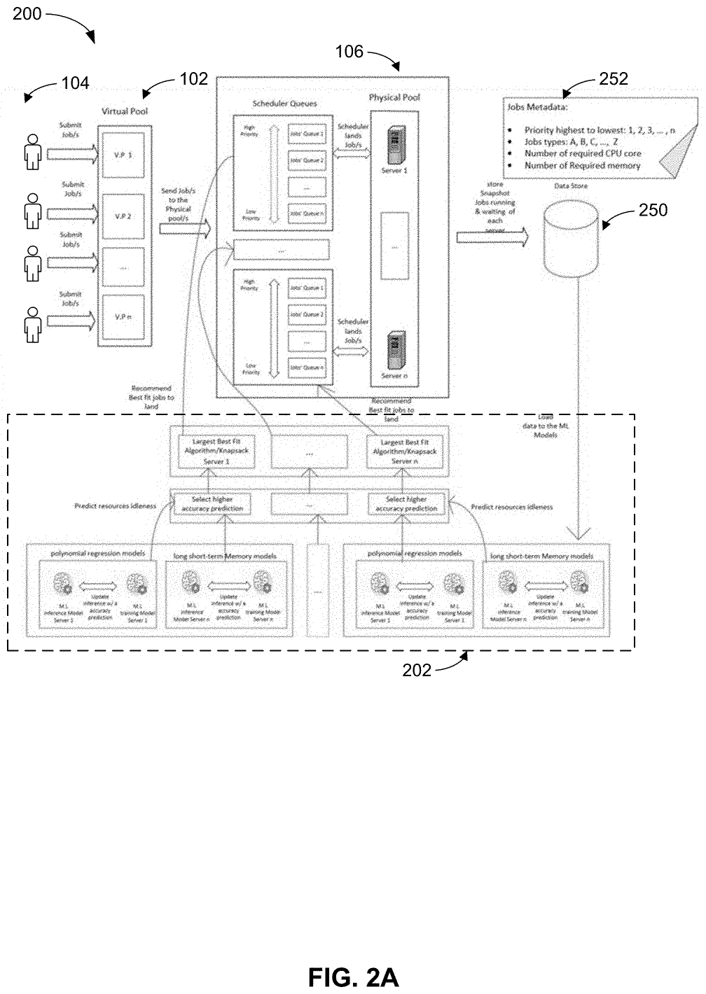

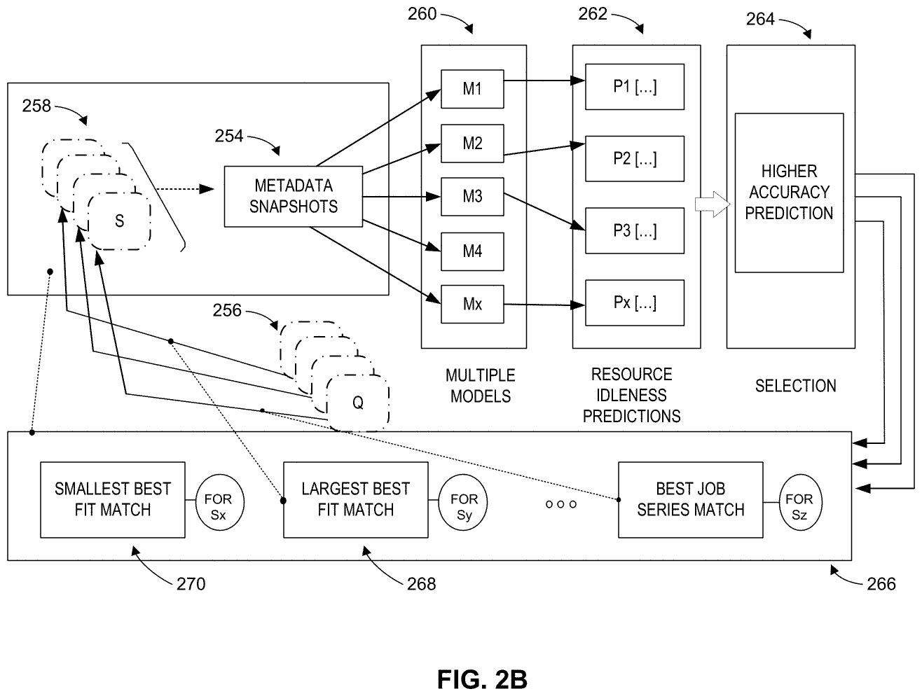

FIG. 2A is a high level schematic illustration of an improved scheduling system 200 to accept job input information from any number of users and improve job scheduling efficiency. The example scheduling system 200 of FIG. 2A includes a scheduling framework 202, which utilizes regression models, neural networks (NNs), recurrent NNs (e.g., long short-term memory (LSTMs)) and other types of models to improve prediction accuracy (e.g., prediction of which resources (e.g., boards) will be idle, which resources will be consumed per unit of time). The example scheduling framework 202 of FIG. 2A blends two or more models and/or modeling approaches to achieve improved output accuracy. In the illustrated example of FIG. 2A, the scheduling system 200 includes similar structure as shown in FIG. 1A.

In the illustrated example of FIG. 2A, the scheduling framework 202 receives and/or otherwise retrieves data from a data store 250 and/or the example scheduling framework 202 populates the example data store 250 based on one or more data acquisition tasks. In some examples, the data store 250 is operated with sequential query language (SQL) systems, and in some examples the data store 250 is operated with Hadoop®. Examples disclosed herein may accommodate any type of data store and/or database system. Example data stored in the data store 250 includes, but is not limited to, information related to jobs and/or job requests. The example data store 250 includes jobs metadata 252 that includes example job priority information (e.g., information indicative of which jobs have a relatively highest versus lowest priority), job types (e.g., information indicative of a type of job), hardware requirements associated with respective jobs (e.g., a number of required CPU cores to accomplish the job, an amount of memory required to accomplish the job, whether the job must include sequential groups of units as compared to disparate boards spread over different units, etc.). In operation, the example scheduling framework 202 generates models to be evaluated for their ability to predict idle resources (e.g., boards, units, etc.) and consumed resources (e.g., boards, units, etc.). Unlike typical model application, such as machine learning models or regression models, the example scheduling framework 202 generates per-resource model combinations. Example models that can be considered by examples disclosed herein include K-nearest neighbor's algorithms, decision tree algorithms, linear regression algorithms, polynomial regression, artificial neural networks, time series models, and support vector machines (SVMs). Examples disclosed herein use a combination of a long short-term memory (LSTM) model and a polynomial regression model. Inside each LSTM model and regression model (e.g., polynomial regression), the example scheduling framework 202 implements a training model and an inference model. The example inference model performs real-time prediction for production, and the training model continuously trains over a period of time. In the event the example training model discovers an improved prediction accuracy rate (e.g., two days from now), then the inference model is updated. Additional detail corresponding to model selection, model training, model resilience management, model accuracy calculations, model certainty calculations and model internal state management is disclosed in further detail below.

The example LSTM model looks back for a period of time. The combination of polynomial regression and LSTM is particularly helpful because in circumstances where a deep history of previously collected data is unavailable, the example polynomial regression model is implemented with a relatively high complexity attribute. However, as historical data becomes more available, the complexity of the polynomial regression model may be reduced (which improves computational efficiency) with a greater predictive reliance on the LSTM output. As such, the combination of models improves the accuracy of predictions and the computational efficiency to determine such predictions. The most accurate model is deemed the winner, but the example of FIG. 2A continuously monitors the model combinations and new inputs to maintain a high degree of predictive accuracy. Furthermore, and as described below in additional detail, improvements to LSTM model layers are realized to increase efficiency.

After the example scheduling framework 202 performs predictions with the particular model combinations (and corresponding attribute settings/combinations), an example optimizer employs one or more optimization algorithms, such as a combinatorial optimization (e.g., Knapsack) and/or a best fit job selection algorithm, as described in further detail below.

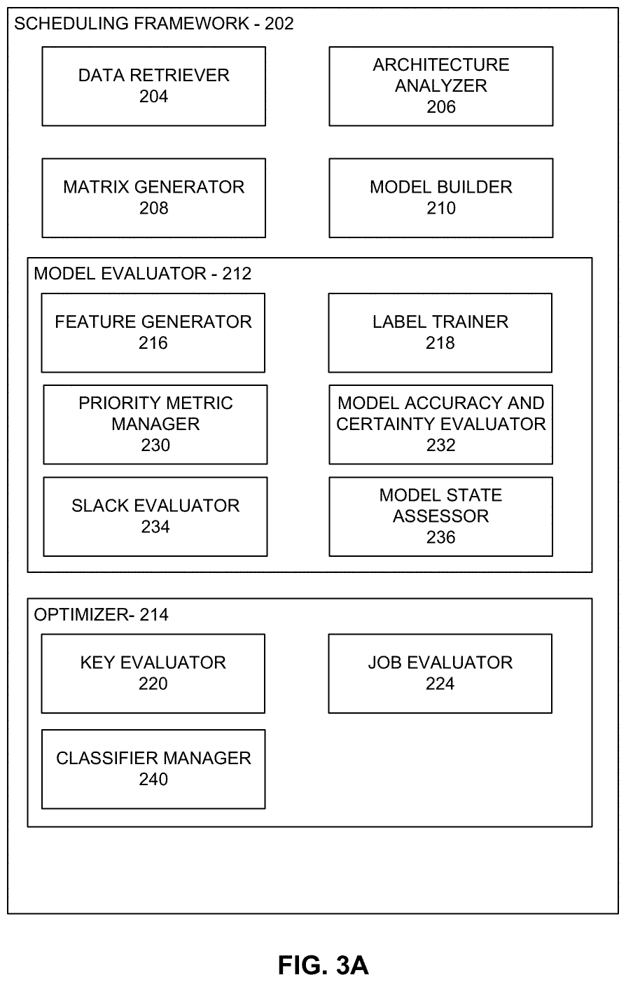

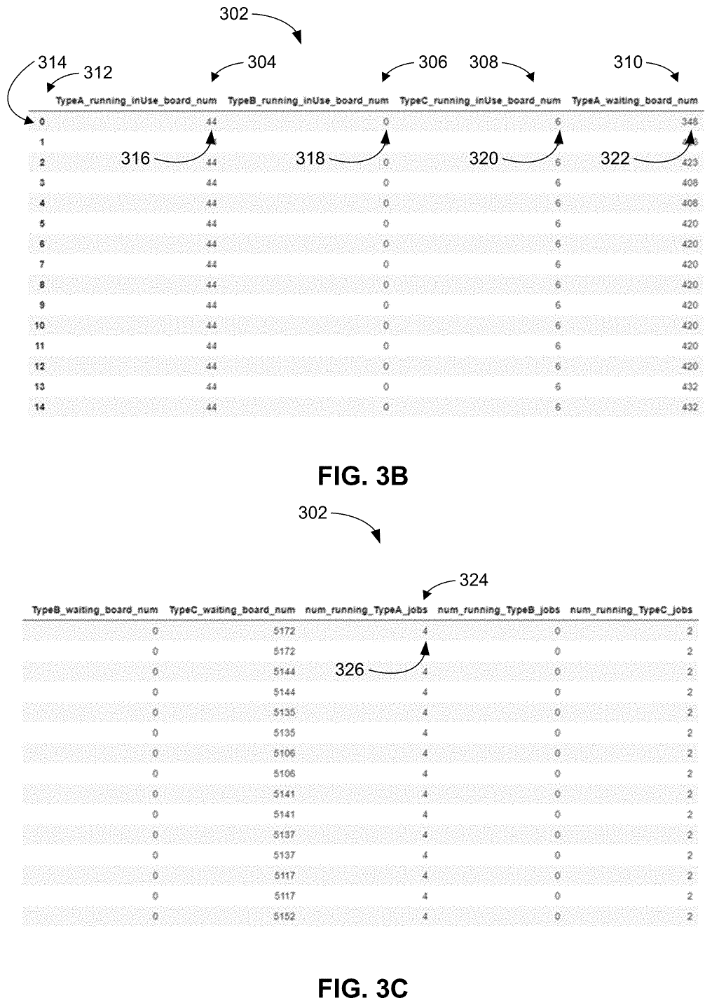

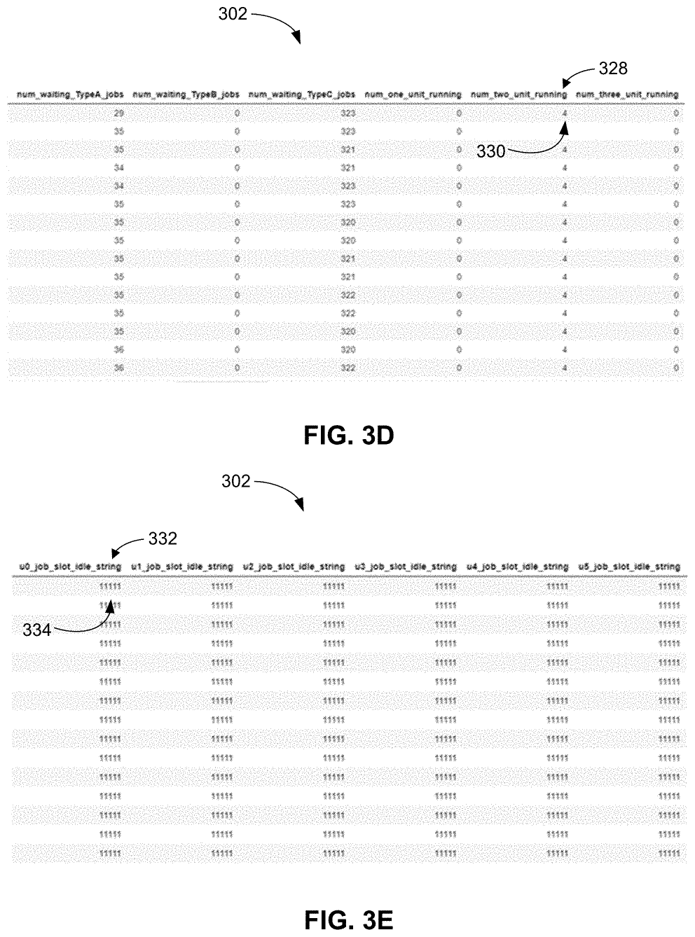

FIG. 2B is a schematic illustration of the example scheduling framework 202 of FIG. 2A. The illustrated example of FIG. 2B is described in a functional level to convey different operational concepts, and structural aspects are described in FIG. 3A below. In the illustrated example of FIG. 2B, metadata snapshots 254 are obtained for jobs from queues 256 and servers 258 at any time during learning, scheduling or job allocation. The example scheduling system 200 identifies a set of candidate models 260 capable of predicting future idleness of the example servers 258. Idleness or consumption predictions 262 for corresponding candidate models 260 are analyzed in a selection engine 264 to determine which of the candidate models 260 should be retained for future prediction efforts.

The example scheduling system 200 derives the predictions based on, in part, the retrieved metadata snapshots 254, and the range of candidate models 260 is unbounded and may include simple to complex models. Generally speaking, while many models may exist, not all of those models perform well in view of current circumstances. However, some models that underperform during a first set of circumstances (e.g., particular job types) may perform particularly well in connection with a second set of circumstances. Still further, while initial calculations of model performance might illustrate a particularly good precision, such precision metrics may be misleading in the event corresponding model recall capabilities are poor.

As described below, different vetting techniques are applied to the example candidate models in real time to maintain an optimum performance of the example scheduling system 200. Because one or more of the candidate models 260 may conflict, which is expected due to the varying techniques of such models 260, the scheduling system applies different model comparison efforts. In some examples, the scheduling system 200 applies bounded statistical variations on model parameters instead of strict reliance on trained fixed values of model parameters. In other words, model parameters are drawn from distributions centered on such fixed values so that inferences can occur on multiple passes to obtain a spread of confidence estimates and certainty estimates. As such, when confidence and/or certainty estimates deviate from one or more thresholds, the example scheduling system 200 facilitates a self-correcting and evolutionary model management process by discarding, retaining, or retraining corresponding models in a proactive manner. Stated differently, the example scheduling system 200 bootstraps itself by trying out and selecting among different predictions using different selection techniques, and introduces model weight variations (e.g., forced perturbations around a mean to facilitate evolutionary/exploratory model adjustments/improvements) in an iterative manner. In some examples, the different selection techniques (sometimes referred to as figures of merit) calculated by the example selection engine 264 include, but are not limited to classification accuracy metrics, logarithmic loss metrics, confusion matrix metrics, area under curve metrics, F1 score metrics that examine a balance between precision and recall, mean absolute error metrics, and mean squared error metrics.

The example scheduling system 200 applies best fit mapping algorithms 266 to the jobs to identify which hardware resources should receive particular jobs. Best fit mapping algorithms include different variations of classic bin-packing techniques, such as a largest best fit (LBF) matching algorithm 268, a smallest best fit (SBF) matching algorithm 270, a knapsack algorithm, etc. To illustrate, the example knapsack algorithm seeks to select weighted jobs in a manner such that a total weight is less than or equal to a total predicted slack for high priority jobs. In some examples, the example LBF matching algorithm 268 seeks to select largest groupings of disparate jobs in view of predicted slack to prevent starvation of relatively larger sized jobs. In still other examples, the example SBF matching algorithm 270 seeks to select smallest groupings of disparate jobs in view of predicted slack to prevent starvation of relatively lower sized jobs.

The example scheduling system 200 also reduces a degree of complexity associated with traditional scheduling algorithms that map in an effort to maximize an objective function (Q). Generally speaking, traditional scheduling systems map jobs in a manner consistent with example Equation 1.

R×S×T→Q (Equation 1)

In the illustrated example of Equation 1, R represents a set of current jobs (e.g., requests), S represents a set of resources (e.g., servers), and T represents telemetry data available from the servers. The example objective function (Q) represents a set of service quality objectives, and the mapping of example Equation 1 generates a new distribution of R×S. To perform this mapping, the traditional scheduling systems typically apply a set of greedy heuristics that become mathematically or algorithmically intractable.

Unlike such traditional scheduling systems, examples disclosed herein reduces a degree of mapping complexity by breaking the effort into disparate parts relating to prediction of future hardware resource availabilities, mapping requests, and performing late assignments when gaps in allocation occur (e.g., as a result of dynamic telemetry information changes). That is, one or more portions of the example scheduling system 200 do not operate in isolation.

FIG. 3A is a schematic illustration of the example scheduling framework 202 of FIGS. 2A and 2B. In the illustrated example of FIG. 3A, the scheduling framework 202 includes an example data retriever 204, an example architecture analyzer 206, an example matrix generator 208, and an example model builder 210. The illustrated example of FIG. 3A also includes an example model evaluator 212, which includes an example feature generator 216, an example label trainer 218, an example priority metric manager 230, an example model accuracy and certainty evaluator 232, an example model state assessor 236, and an example slack evaluator 234. The illustrated example of FIG. 3A also includes an example optimizer 214, which includes an example key evaluator 220, and an example job evaluator 224 and an example classifier manager 240. In some examples, the example data retriever 204 implements means for retrieving data, which is sometimes referred to herein as a retrieving data means. In some examples, the example architecture analyzer 206 implements means for analyzing architecture, which is sometimes referred to herein as a architecture analyzing means. In some examples, the example matrix generator 208 implements means for matrix generation, which is sometimes referred to herein as a matrix generation means. In some examples, the example model builder 210 implements means for building models, which is sometimes referred to herein as a model building means. In some examples, the example model evaluator 212 implements means for evaluating models, which is sometimes referred to herein as a model evaluating means. In some examples, the example feature generator 216 implements means for generating features, which is sometimes referred to herein as a feature generating means. In some examples, the example label trainer 218 implements means for training labels, which is sometimes referred to herein as a label training means. In some examples, the example priority metric manager 230 implements means for managing priority metrics, which is sometimes referred to herein as a priority metric managing means. In some examples, the example model accuracy and certainty evaluator 232 implements means for evaluating model accuracy and certainty, which is sometimes referred to herein as a model accuracy and certainty evaluating means. In some examples, the example model state assessor 236 implements means for state assessing, which is sometimes referred to herein as a state assessing means. In some examples, the example slack evaluator 234 implements means for evaluating slack, which is sometimes referred to herein as a slack evaluating means. In some examples, the example optimizer 214 implements means for optimizing, which is sometimes referred to herein as an optimizing means. In some examples, the example key evaluator 220 implements means for evaluating keys, which is sometimes referred to herein as a key evaluating means. In some examples, the example job evaluator 224 implements means for evaluating jobs, which is sometimes referred to herein as a job evaluating means. In some examples, the example classifier manager 240 implements means for managing classifiers, which is sometimes referred to herein as a classifier managing means.

In operation, the example data retriever 202 retrieves data from a data store (e.g., the example jobs metadata 252) and the example architecture analyzer 206 retrieves target hardware architecture information, such as an architecture map. In some examples, the architecture analyzer 206 analyzes communicatively connected hardware resources, such as the example cluster 150 of FIG. 1B. The example architecture analyzer 206 determines a number of available servers 152, a number of associated units 154, and a number of corresponding boards 156 contained therein. As described in further detail below, the example architecture analyzer 206 coordinates with the example matrix generator 208 to label each available resource that can assist in job task processing. The example matrix generator 208 designs a dataset matrix, and the example architecture analyzer 206 selects one or more resources (e.g., a server resource, a set of server resources, edge-based resources (e.g., IoT devices)) that are to be predicted for consumption activity. The example dataset matrix designed by the example matrix generator 208 may include (e.g., in connection with the example hardware resources of FIG. 1B):
A total number of boards running respective job types
A total number of boards to run all waiting job types
A total number of individual jobs running
A total number of individual jobs waiting
A five-digit numerical number representing in-use and free/idle individual boards in respective units
   For example, a value of “1” represents a board is “in use” (e.g., a use status), while a value of “2” represents a board is idle/free. A value of “3” represents a particular board is not available or locked (e.g., a locked status). In some examples, the value of “3” locked status is indicative of a particular board that is not expected to become available at a later time, which is sometimes caused by board damage or other reasons of unavailability. As such, in a first unit (e.g., unit zero), a value of 11111 means all boards are in use. A value of 22222 means all boards are idle, and a value of 22221 means four boards are idle and one is in-use.

FIGS. 3B through 3E illustrate example tables generated by the example matrix generator 208, in which the tables cultivate information associated with communicatively connected resources of one or more clusters, such as the example cluster 150 of FIG. 1B. In the illustrated example of FIG. 3B, a job tracking table 302 includes a type-A-running column 304, a type-B-running column 306, a type-C-running column 308 and a type-A waiting column 310. Briefly, and described in further detail below, different job requests are associated with different objectives/types. An example first type of job (e.g., type-A) may include particular resource allocation nuances that differ from a second type of job (e.g., type-B). An example job number column 312 illustrates a job number identifier, which spans from job zero through job fourteen in the illustrated example of FIG. 3B. An example first row 314 of the example job tracking table 302 includes information associated with a first job (job zero), which indicates that there are currently 44 (forty-four) boards currently executing (e.g., running) a job of type-A (see reference 316). Additionally, the example first row 314 indicates that job zero has zero boards currently executing a job of type-B (see reference 318), six boards currently executing a job of type-C (see reference 320), and 348 jobs awaiting a board allocation of type-A jobs (see reference 322).

As described above, different job types may have different requirements when they are executed. In some examples, a first job type (e.g., job type “A”) is deemed of a relatively higher priority than a second job type (e.g., job type “B”). As such, efforts to allocate a relatively higher job type to respective processing resources occurs prior to allocation of a relatively lower job type to those processing resources. However, in some examples the mere availability of resources does not necessarily determine that those resources should be assigned to/by a corresponding job. That is, particular jobs may require unique resource conditions, such as a particular number of processing cores, a particular number of sequential boards within a unit, a particular number of sequential units in which all of the associated boards are dedicated to the job, etc. Such conditions are detected and cultivated by the example matrix generator 208.

In the illustrated example of FIG. 3C, the example matrix generator 208 generated additional metrics/details of the example job tracking table 302. Generally speaking, FIGS. 3B through 3E may represent the same job tracking table 302 with different types of cultivated information that is associated with jobs, job types, necessary job conditions and/or associated resources that have been allocated to respective jobs. FIG. 3C illustrates an example type-A-job-count column 324 that indicates four jobs are currently running of type A (see reference 326). Worth noting is that the illustrated example of FIG. 3B indicates that 44 boards are dedicated to jobs of type “A,” and FIG. 3C indicates that those 44 boards are distributed to four separate instances of a job of type “A.”

In the illustrated example of FIG. 3D, the example matrix generator 208 generated additional metrics/details of the example job tracking table 302. FIG. 3D illustrates an example multiple-unit-requirement column 328 that indicates four jobs are currently running that each require an allocation of two units (see reference 330). In some examples, the multiple resource requirement must also be sequential in nature.

In the illustrated example of FIG. 3E, the example matrix generator 208 generated additional metrics/details of the example job tracking table 302. FIG. 3E illustrates an example unit zero binary string column 332 having an associated binary string (see reference 334) indicative of a board status for each respective board within unit zero. For instance, because the example binary string 334 includes five (5) integer values, then unit zero has five boards. Additionally, each integer within the example binary string 334 may include a particular value to identify a board status. In the illustrated example of FIG. 3E, an integer value of “1” represents a board is in-use (and unavailable for any other job). An integer value of “2” represents a board is idle, thus capable of being assigned to (or capable of having a job assigned to it) a job. An integer value of “3” represents a board is locked, which may be indicative of a problem/defect of the board.

The data shown in the illustrated examples of FIGS. 3B through 3E may be considered a temporal snapshot of the hardware and associated jobs assigned thereto. Snapshots of the hardware and associated jobs may be performed by the example scheduling framework 202 at any frequency of interest, such as once per minute, once per hour, etc. Additionally, and as described above, this particular aspect of the scheduling framework 202 may operate in isolation and/or otherwise independently of one or more other operations directed to model training, model analysis and/or job assignment tasks. The data associated with each snapshot may be stored in a memory, such as the example data store 250 of FIG. 2, in which the data is later used in prediction tasks. In particular, the example job tracking table 302 shown in FIGS. 3B through 3E represent a characteristics structure that exposes behaviors of the example scheduling system 200. In other words, typical machine learning processes acquire available data in an effort to make predictions, associations and/or identify emerging patterns. Such machine learning efforts are particularly helpful when the volume of associated behavior data is particularly large, and a corresponding number of unique characteristics are relatively numerous. The example job tracking table 302 generates a deeper level of characteristic granularity to help the machine learning process identify such predictions, associations and/or emerging patterns. Absent the example job tracking table 302, subsequent machine learning operations may not include a sufficient number and/or diversity of unique system characteristics to identify such emerging patterns.

Returning to the illustrated example of FIG. 3A, the example model builder 210 loads a subset of data to the LSTM model, and loads a subset of data to the polynomial regression model, and the example model evaluator 212 evaluates the models to generate prediction metrics. Additionally, the example optimizer 214 applies one or more optimization algorithms using prediction metrics.

In some examples, the scheduling framework 202 addresses the circumstances where many different types of inputs are obtained and passed to candidate and selected models. Such inputs can be overwhelming and result in instrumentation and data processing overkill on the one hand, and result in overfitting due to high collinearities of observations on the other hand. To reduce these effects, examples disclosed herein group the jobs into different or otherwise discrete types based on different criteria (e.g., sources of the job requests, job request tags/metadata, etc.). Stated differently, examples disclosed herein generate footprints as logical subgroupings of job requests. In this manner, particular job types can be delivered to corresponding models that are more capable of exhibiting reliable predictions of resource availability.

In operation, the example data retriever 204 of FIG. 3A acquires (a) job-type data of currently running jobs (on hardware resources), (b) job-type data of jobs not yet assigned to hardware resources, but in one or more queues, and (c) current hardware availability metrics (e.g., a quantity of available hardware resources, whether such resources are continuous, resource types, etc.). The example job evaluator 224 performs job-type grouping based on any type of desired characteristic, such as job-types that require a specific number of processing cores, job-types that require physically adjacent hardware resources interconnected with particular bus bandwidth capabilities, etc. The example classifier manager 240 applies one or more classification algorithms (e.g., a decision tree, permutation tree, etc.) to generate candidate footprints, and applies a normalizer to fit the footprints to a distribution. In some examples, the normalizer is a fit transform function, such as example SciKit-learn® algorithms. The example optimizer 214 then assigns candidate models that match characteristics of a largest portion of the distribution, thereby matching particular jobs with the models most likely to exhibit optimized prediction metrics.

During the operations associated with evaluating models to generate the prediction metrics, the example feature generator 216 imports linear regression and polynomial features, and sets feature values accordingly. The example label trainer 218 fits a transformed dataset and trains the corresponding labels. In some examples, the label trainer 218 both fits and transforms the dataset in one function call involving, for instance, considerations of standard deviation, average(s), normalizations, etc. The example model evaluator 212 generates predictions using the polynomial regression model and the LSTM model, and determines if the prediction value accuracy satisfies one or more threshold(s), as described in further detail below. If not, then the model is retrained. If so, the model is saved and used for further optimization analysis.

During such optimization, the example data retriever obtains inputs, and the example key evaluator 220 initiates a loop that starts with a key job size in reverse order (e.g., using a dictionary data structure having one or more keys). The example key evaluator 220 determines whether all keys have been considered or otherwise analyzed and, if not, determines whether the key is empty. If so, a next key is selected. Otherwise the example architecture analyzer 206 determines if a number of available resources is zero. If not, the example key evaluator 220 loops through job identifiers (IDs) for the selected key. The example job size evaluator 224 determines whether the job size is less than or equal to a number of available resources (e.g., a number of processors of a hardware suite). If so, then the job ID is appended, and the job size evaluator 224 removes the appended job from the list to prevent re-analysis of the same. The example job size evaluator 224 decrements the job size value and determines whether it is greater than a number of available resources. If not, then the next job ID is selected by the example key evaluator 220. However, if so then the example key evaluator 220 selects a next key.

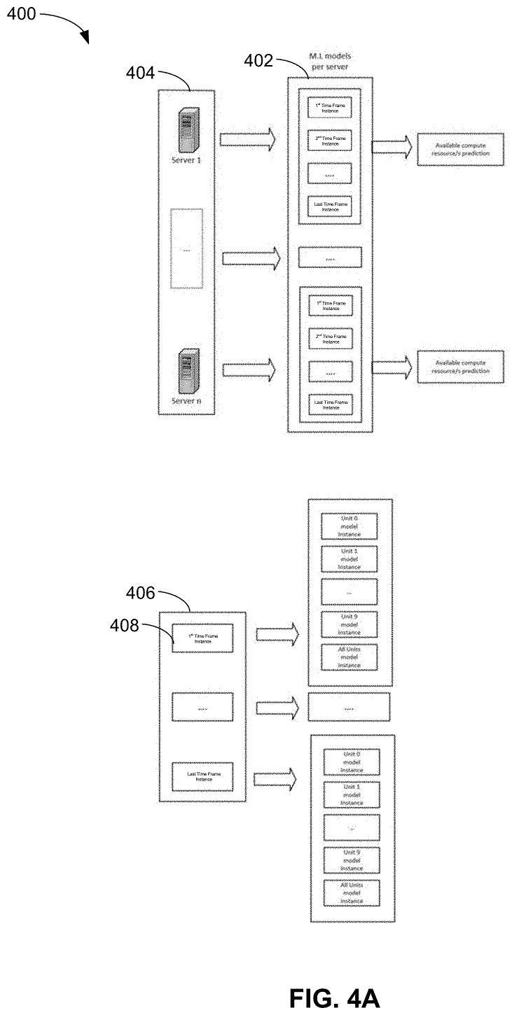

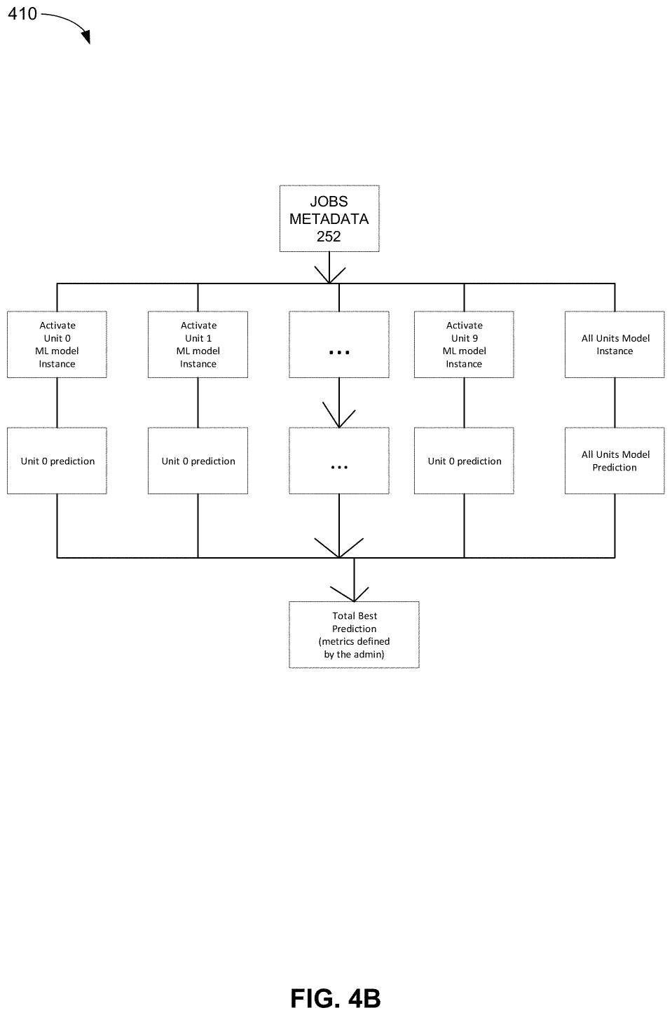

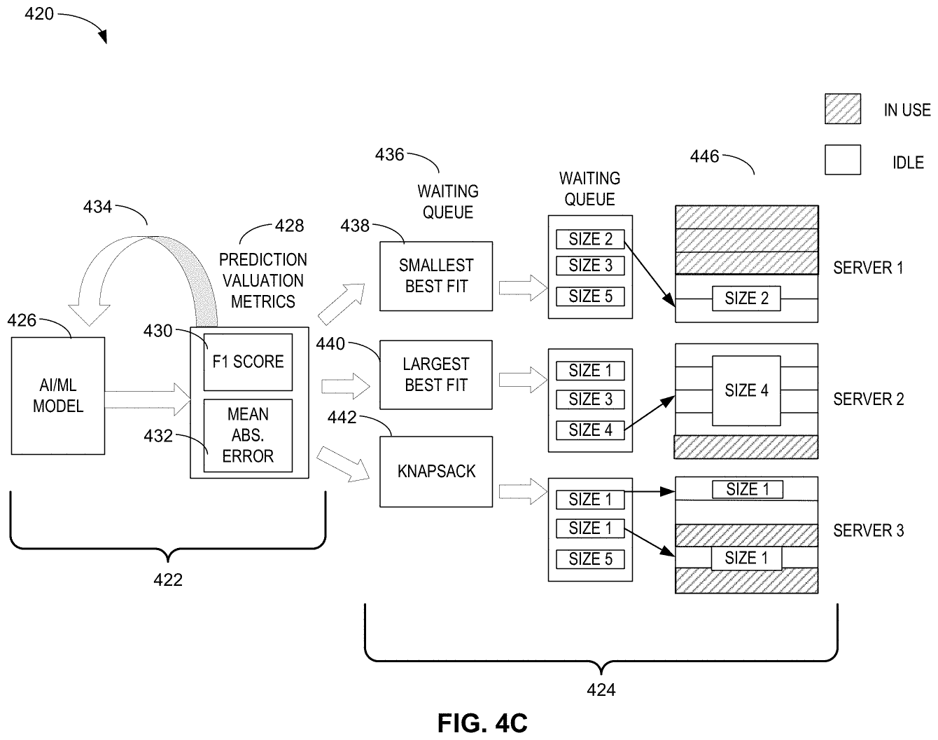

In some examples, the scheduling framework 202 employs a machine learning architecture in which a user can decide a timeframe for which models should predict available resources. FIG. 4A is a schematic illustration of example machine learning model assignments 400 in which machine learning models are assigned on a per-server (e.g., per-resource) 402 basis. In the illustrated example of FIG. 4A, an example temporal (e.g., one-hour) prediction model architecture instance is shown for emulation resources. In the illustrated example of FIG. 4A, each compute resource 404 (e.g., server) contains 24 instances of a model 406 (e.g., one for each hour), but the example temporal representations of FIG. 4A are used for example purposes and not limitation. A number of model instances is equal to 24 divided by a desired timeframe length in hours. In each example temporal (e.g., hour) model (e.g., a first time frame instance 408, a second time frame instance, etc.), there are 11 example instances of models representing each unit and the computing resource.

FIG. 4B is an example flowchart 410 of the example schematic illustration of FIG. 4A. In the illustrated example of FIG. 4B, jobs metadata 252 (e.g., from the example data store 250) and/or data from snapshots of the example job tracking table 302 are provided as inputs. In some examples, data is provided in a parallel manner to activate models in a temporal order, which is followed by one or more predictions on a per-unit basis.

Examples disclosed herein also improve a degree of resilience of the one or more candidate models used for predicting resource availability. In particular, examples disclosed herein perform an assessment of model risk reduction in view of changing priority metrics/directives. In some examples disclosed herein, the scheduling framework 202 assesses model accuracy and model certainty, thereby allowing particular weights to be applied to models based on their performance. In still further examples, the scheduling framework 202 assesses slack of the resource allocation. Generally speaking, slack represents an intentional effort to leave out one or more portions of available resources for future opportunities. For instance, in the event a particular job type requires a sequence of two or more communicatively connected physically adjacent hardware resources, but no such availability currently exists, the example scheduling framework 202 withholds assignment of such physically adjacent resources to that when they complete a current job, they are then available for the specific job type. In still further examples, the scheduling framework 202 assesses internal states of models to identify one or more layers that may not be performing in a relevant manner. The aforementioned model resilience features are discussed below, in turn.

To assess model risk reduction, the example priority metric manager 230 monitors changes in emergent conditions and determines whether priority metrics have been altered. In some circumstances, particular job types are dynamically assigned different priorities “on the fly.” If left unmonitored, then these dynamic requests (e.g., changes input by a user of the scheduling system 200) may be left unaddressed by traditional scheduling systems. In some circumstances, a first latency requirement exists at a first time, while a second (different) latency requirement exists at a second time (e.g., a maximum amount of time a job is to take when being processed by allocated hardware resources). In a standard/traditional LSTM implementation, rigid or otherwise static computations are performed in connection with a cost function. As such, the two different latency requirements are not weighed differently.

However, the example priority metric manager 230 facilitates an evaluation (of priority metrics) at a first time, and a selection at a second time to accommodate for potential metric changes. In other words, a flexible risk reduction occurs. The example priority metric manager 230 retrieves the priority metrics on a periodic, aperiodic, scheduled or manual basis and determines whether such priority metrics have changed since a prior review. In some examples, particular priority metrics are compared to a threshold that, if satisfied, causes the priority metric manager 230 to adjust one or more weights of a cost function. As such, the cost function can evaluate rewards in a manner consistent with one or more recently changed priorities.

To assess model accuracy and certainty, the example model accuracy and certainty evaluator 232 selects a model of interest. Model accuracy and certainty are calculated by the example evaluator 232 to determine relative performance metrics. Generally speaking, an accuracy metric of a particular model is a representation of how well that model correctly predicts an outcome (e.g., in the next 30 seconds there will be a 60% availability in one or more resources). When such accuracy metrics are known, corresponding weights can be adjusted to the output generated by that model (e.g., a relatively higher weight when the model performs relatively more accurately, and vice versa). A certainty metric of a particular model, on the other hand, is a representation of the consistency of the model of interest. Certainty reflects insight into how the model was trained. For instance, a model might have the ability to perform with a threshold degree of accuracy for one type of input, but that model performance might change substantially in the event the input deviates from some operational norm, thereby negatively affecting the consistency of that model. In other words, the observation that the model performed well could be considered a fluke, but that model might not perform in a consistent manner or otherwise be trusted in a relatively more diverse input setting.

Examples disclosed herein address these two characteristics of models, and measure model certainty using one or more Bayesian procedures/analysis. In some examples, the model accuracy and certainty evaluator 232 perturbs models and then re-calculates metrics of accuracy and certainty to more thoroughly ascertain whether the candidate model is more or less capable (or trustworthy) when compared to other candidate models. Again, these efforts to capitalize on model confidence may be performed by the example simulation framework 202 in an independent manner of one or more other scheduling tasks. The resulting accuracy and consistency metrics determined by the example model accuracy and certainty evaluator 232 are normalized to generate an aggregate score that can be applied (weighted) to each model.

To assess slack metrics of the available resources, the example slack evaluator 234 calculates an amount (e.g., a quantity of available cores) of unallocated resources for a time period of interest. In the event the example slack evaluator 234 determines that one or more jobs in a queue are stalled, then slack is allocated for future opportunities and the cost function is adjusted to reflect the importance of one or more priorities associated with the queued jobs.

To assess internal states of models, the example model state assessor 236 selects a model of interest, such as an LSTM model. One of the layers of the selected LSTM model is selected by the model state assessor 236, and a probability corresponding to that layer is calculated. Generally speaking, some states are relatively more likely to occur when compared to other states. Using the game of chess as an analogy, some opponent moves (corresponding to a first layer) are more likely to occur than other opponent moves (corresponding to a second layer) when the opponent is seeking to win the game. As such, particular moves that are less likely represent portions of the LSTM model that require less or no attention during inference activity, thereby reducing model energy requirements and computational resource consumption needs. The example model state assessor 236 compares layer probability values to one or more thresholds that, if satisfied, determine whether that particular layer is retained (for further inferences) or culled (to conserve computational resources).

As discussed above, divide-and-conquer techniques implemented by examples disclosed herein help to simplify machine learning operations without forcing a linear scheduling effort in real time. To illustrate, FIG. 4C is a schematic illustration of an example high-level scheduling system 420 to apply a divide and conquer approach to job scheduling efforts. In the illustrated example of FIG. 4C, the scheduling system 420 includes a first level portion 422 corresponding to predicting an overall degree of resource idleness, and a second level portion 424 corresponding to finding best jobs to schedule to the resources. Consistent with the above, these portions are not necessarily operating in a lock-step or series fashion, but can be performed independently as system processing bandwidth and/or dynamic data input is available.

The example model builder 210 acquires a list of models 426, and the example model accuracy and certainty evaluator 232 calculates one or more prediction valuation metrics 428 (e.g., accuracy calculations, confidence calculations, etc.). In some examples, the metrics correspond to F1 score calculations 430 (e.g., a hybridized score based on model precision capabilities and model recall capabilities) and/or mean absolute error calculations 432. In the event the model builder 210 determines that one or more thresholds are not satisfied, an alternate model is selected 434. Stated differently, thresholds that are not satisfied triggers one or more retraining efforts and/or alternate model selections. However, if the one or more thresholds is satisfied, then the example optimizer 214 retains the model for job selection in a waiting queue 436.

As time goes by, the example waiting queue 436 builds and the example second level portion 424 proceeds when sufficient jobs reside in the example waiting queue 436, or when particularly high priority jobs require immediate attention. The example classification manager 240 applies one or more greedy algorithms to an objective function (e.g., the cost function) in an effort to identify where specific jobs within the queue 436 should be assigned. The greedy algorithms include, but are not limited to a smallest best fit (SBF) algorithm 438, a largest best fit (LBF) algorithm 440, and a knapsack algorithm 442.

The example greedy algorithms of the example waiting queue 436 group the jobs in different ways corresponding to the particular algorithm objectives, which are shown in a secondary waiting queue 444. The example optimizer 214 then assigns the matching jobs to available resources 446.

While an example manner of implementing the improved scheduling system 200 and the example scheduling framework 202 of FIGS. 2, 3A-3E, 4A and 4B are illustrated in FIGS. 2, 3A-3E, 4A and 4B one or more of the elements, processes and/or devices illustrated in FIGS. 2, 3A-3E, 4A and 4B may be combined, divided, re-arranged, omitted, eliminated and/or implemented in any other way. Further, the example data retriever 204, the example architecture analyzer 206, the example matrix generator 208, the example model builder 210, the example model evaluator 212, the example feature generator 216, the example label trainer 218, the example priority metric manager 230, the example model accuracy and certainty evaluator 232, the example slack evaluator 234, the example model state assessor 236, the example optimizer 214, the example key evaluator 220, the example job evaluator 224, the example classifier manager 240 and/or, more generally, the example scheduling framework 202 of FIGS. 2A, 2B and 3A may be implemented by hardware, software, firmware and/or any combination of hardware, software and/or firmware. Thus, for example, any of the example data retriever 204, the example architecture analyzer 206, the example matrix generator 208, the example model builder 210, the example model evaluator 212, the example feature generator 216, the example label trainer 218, the example priority metric manager 230, the example model accuracy and certainty evaluator 232, the example slack evaluator 234, the example model state assessor 236, the example optimizer 214, the example key evaluator 220, the example job evaluator 224, the example classifier manager 240 and/or, more generally, the example scheduling framework 202 of FIGS. 2A, 2B and 3A could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data retriever 204, the example architecture analyzer 206, the example matrix generator 208, the example model builder 210, the example model evaluator 212, the example feature generator 216, the example label trainer 218, the example priority metric manager 230, the example model accuracy and certainty evaluator 232, the example slack evaluator 234, the example model state assessor 236, the example optimizer 214, the example key evaluator 220, the example job evaluator 224, the example classifier manager 240 and/or, more generally, the example scheduling framework 202 of FIGS. 2A, 2B and 3A is/are hereby expressly defined to include a non-transitory computer readable storage device or storage disk such as a memory, a digital versatile disk (DVD), a compact disk (CD), a Blu-ray disk, etc. including the software and/or firmware. Further still, the example scheduling framework 202 of FIGS. 2A, 2B and 3A may include one or more elements, processes and/or devices in addition to, or instead of, those illustrated in FIGS. 2A, 2B and/or 3A, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

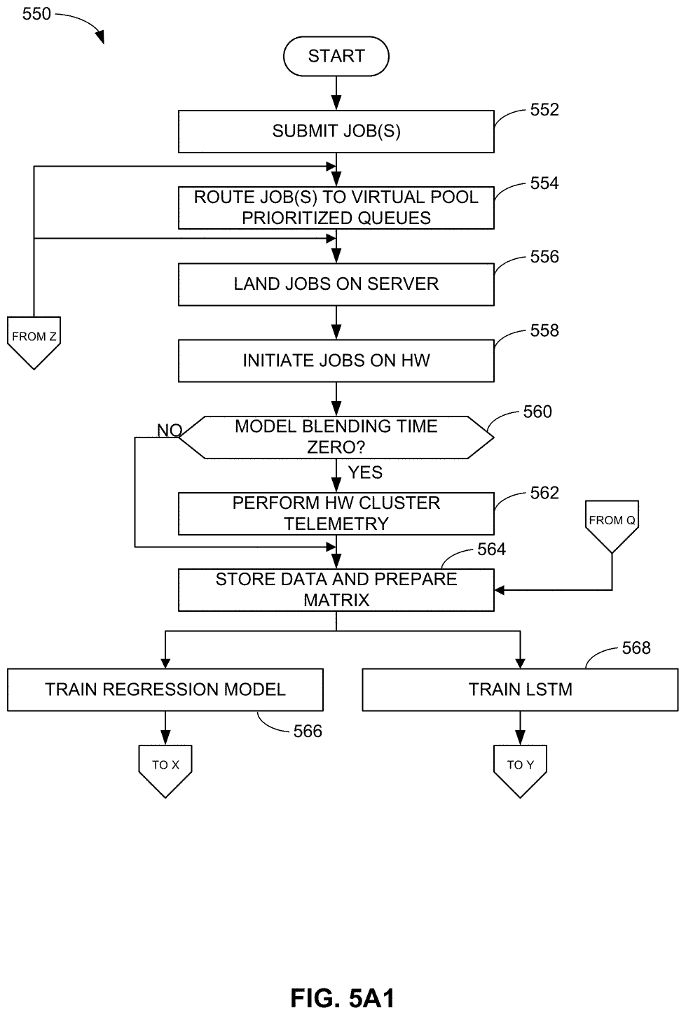

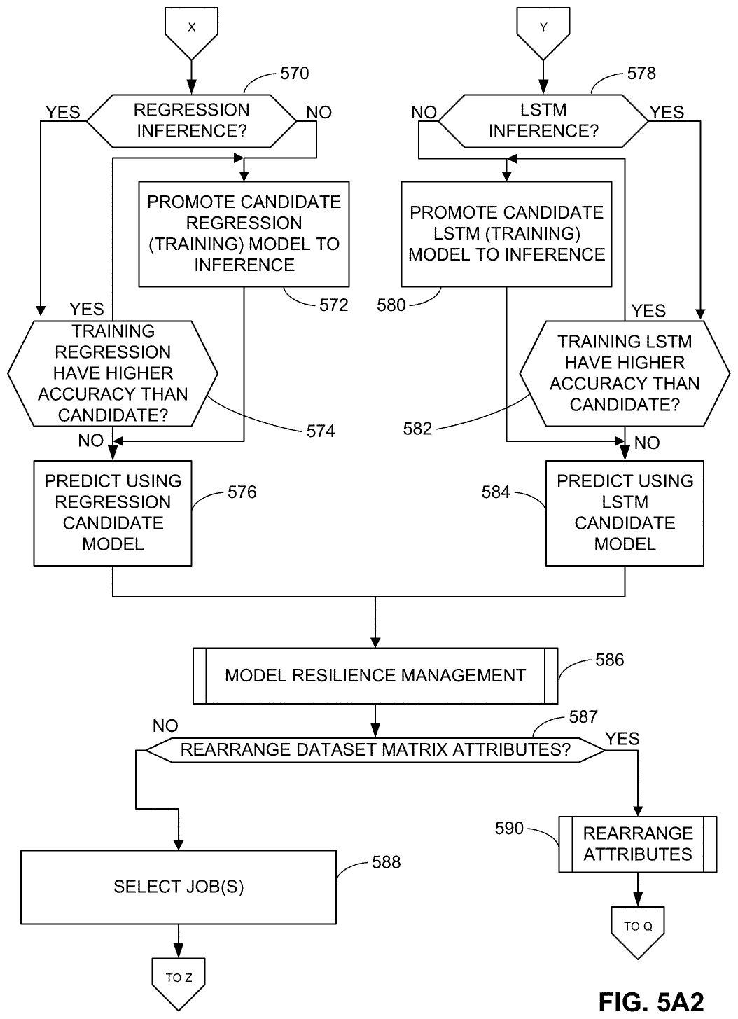

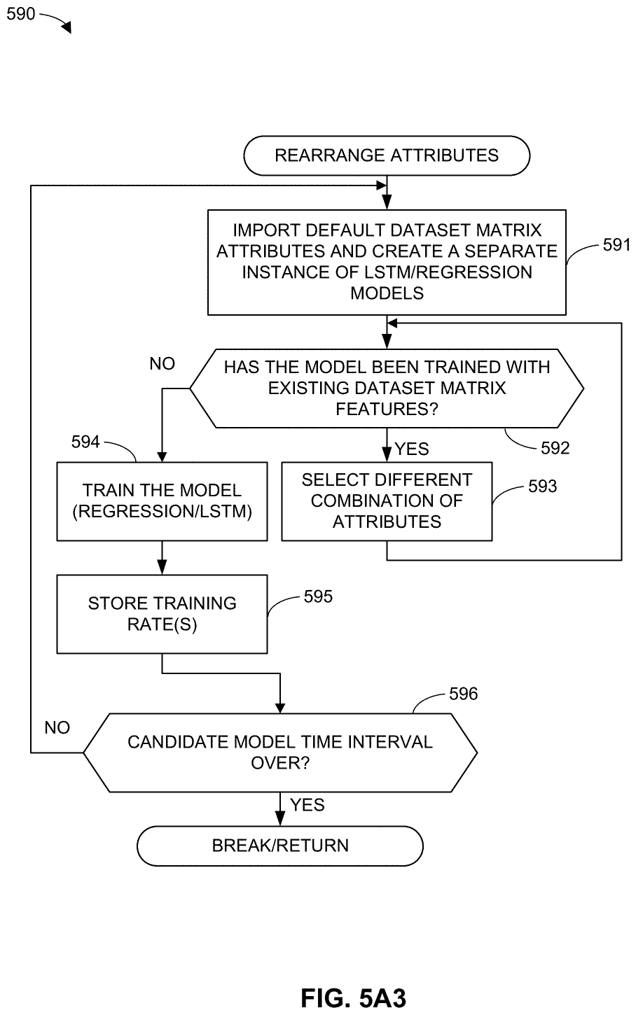

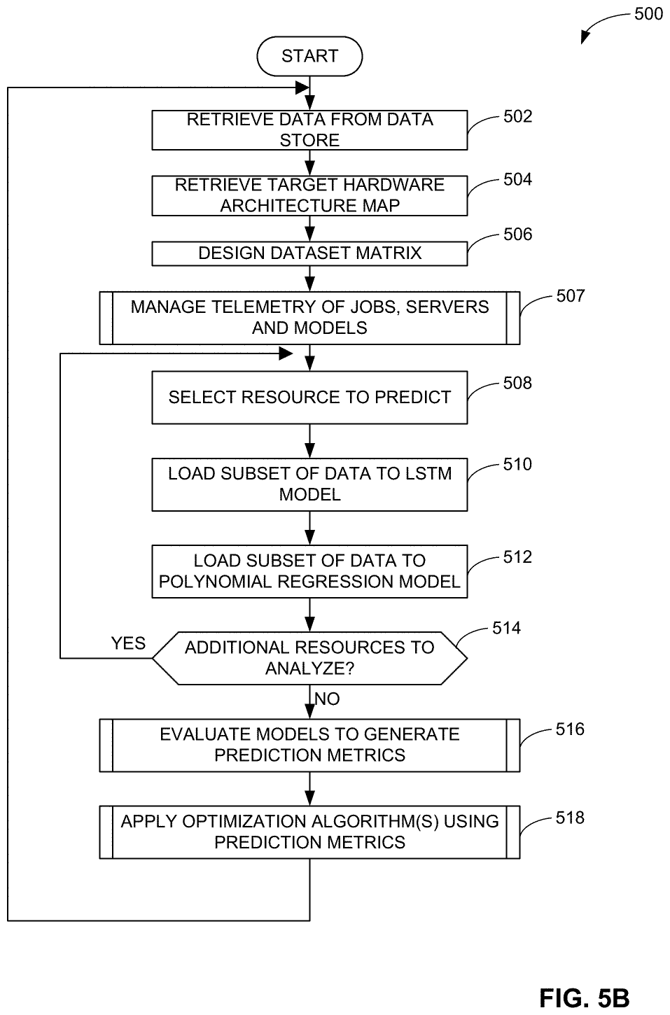

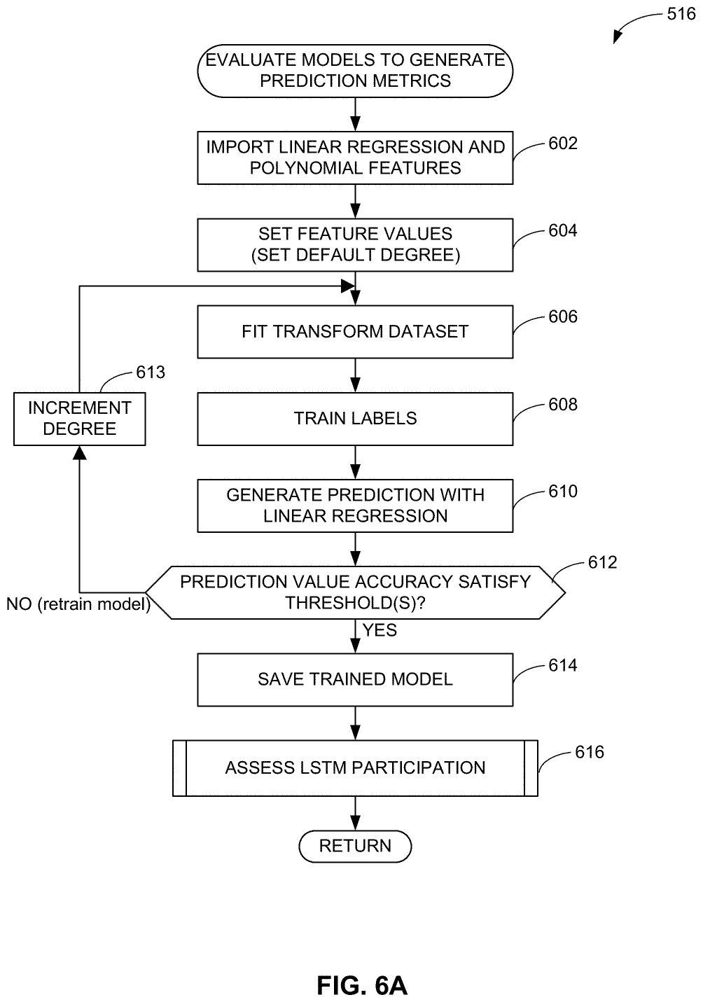

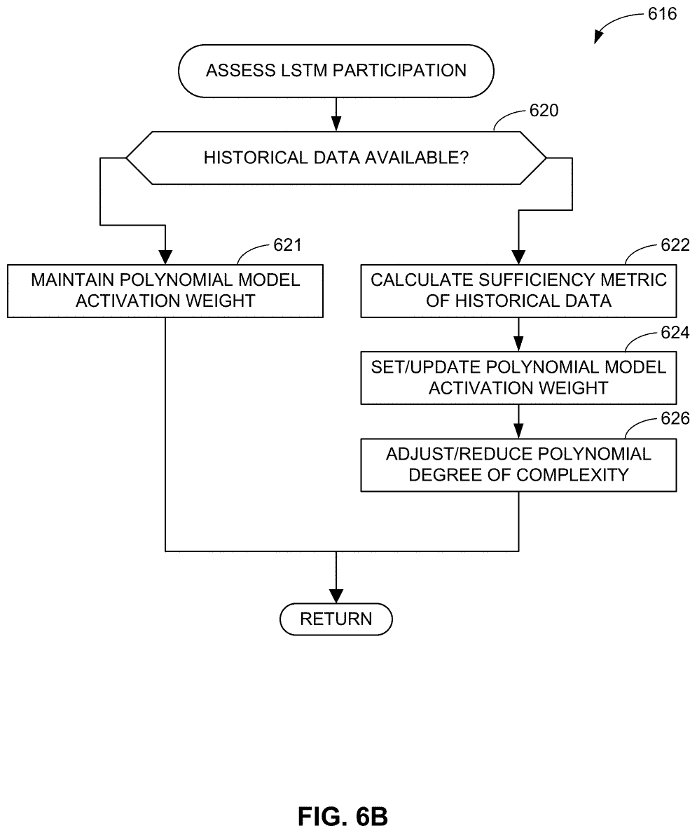

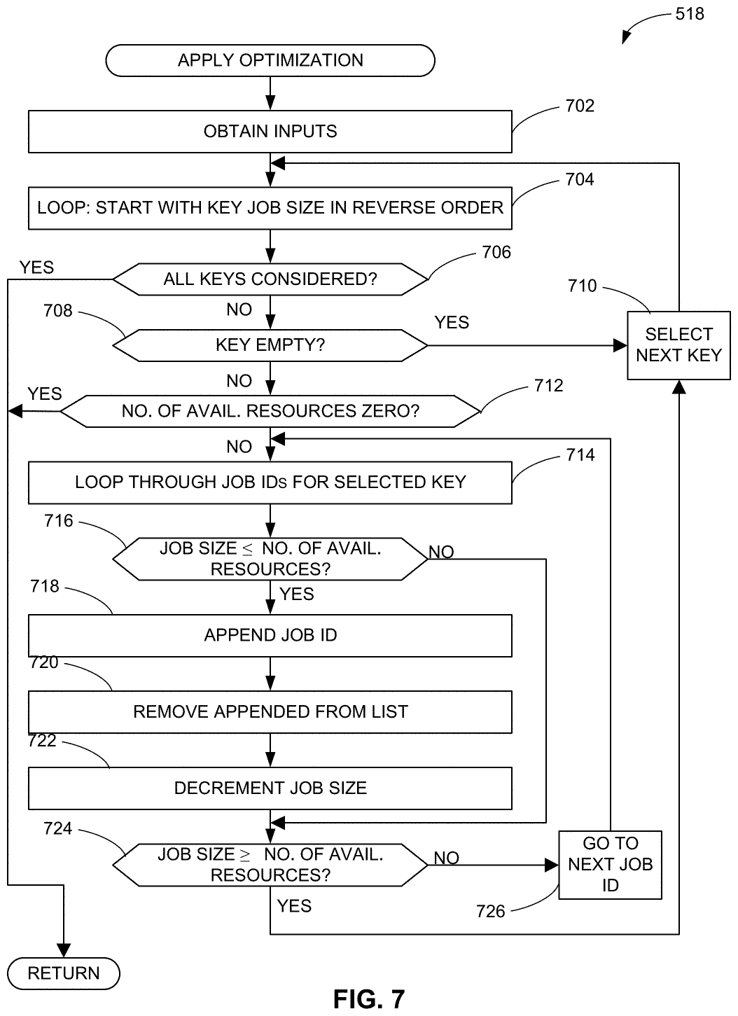

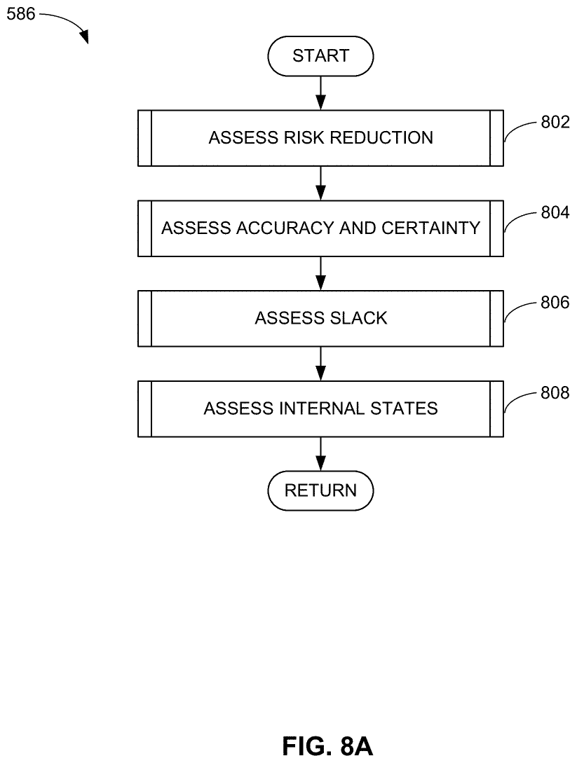

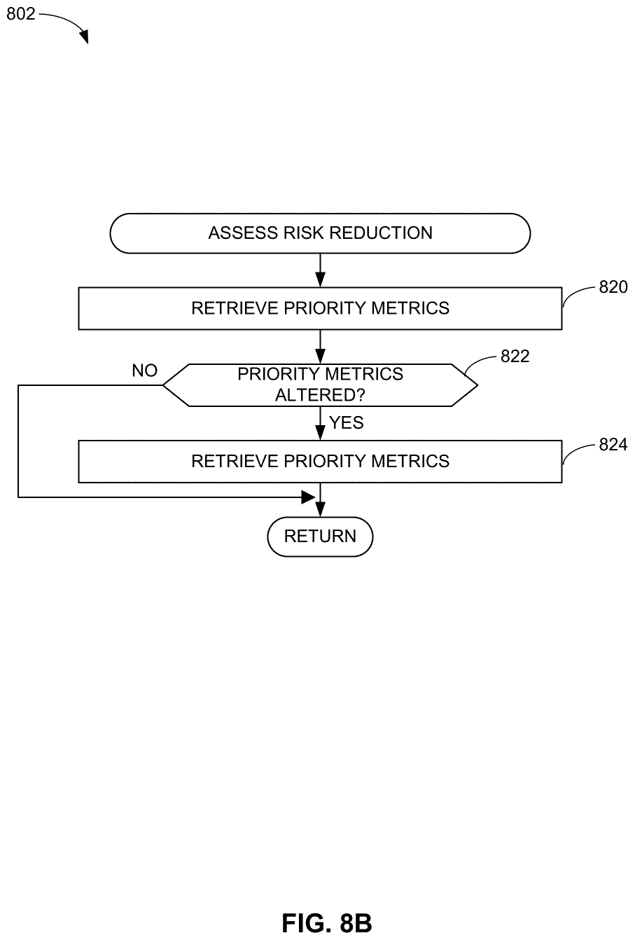

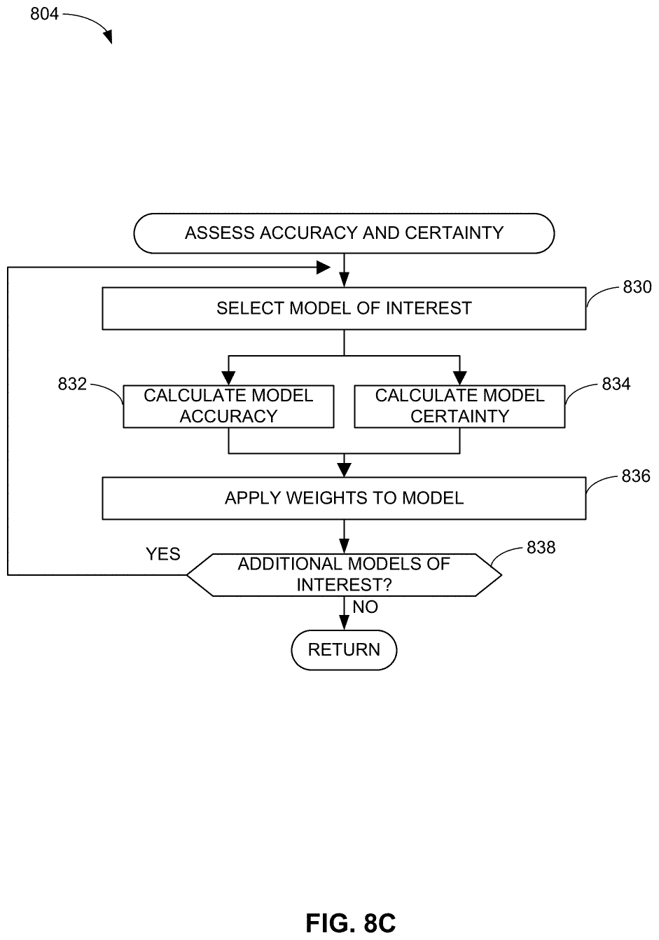

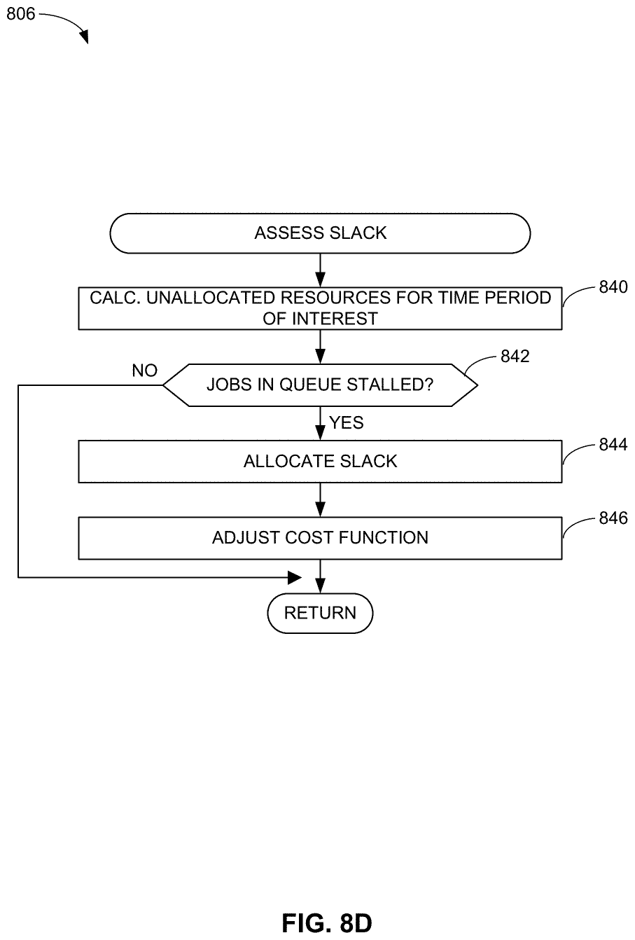

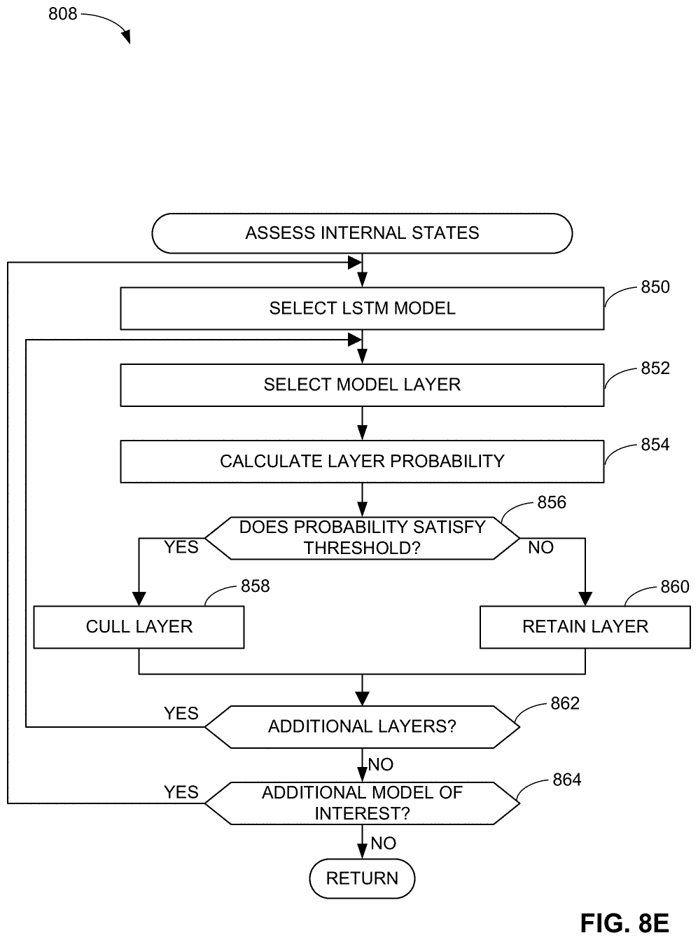

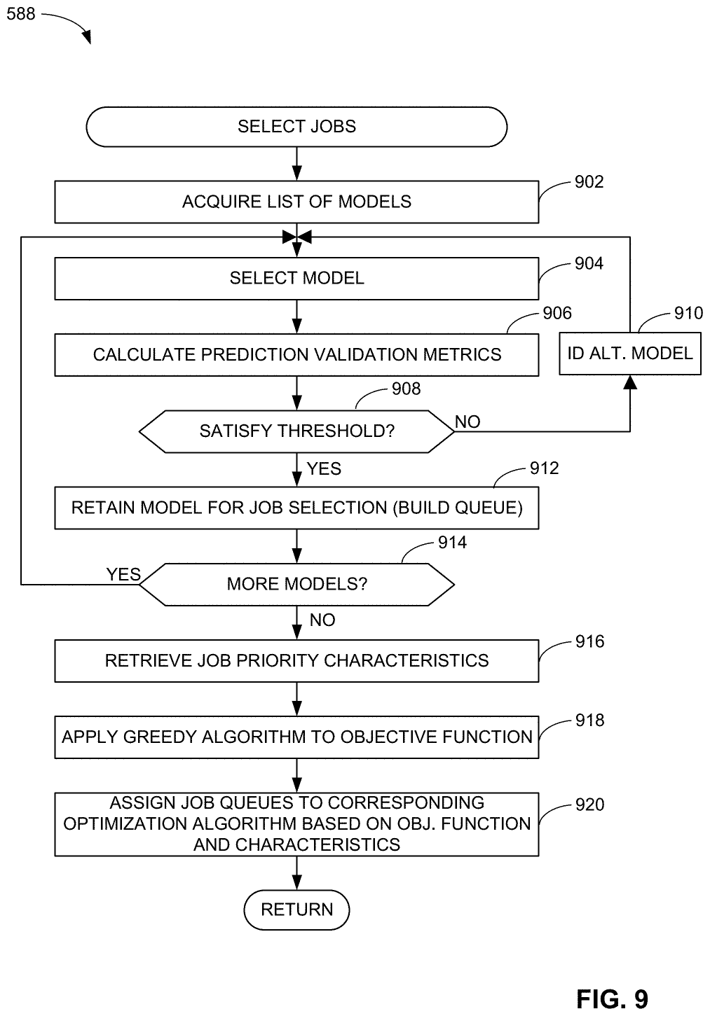

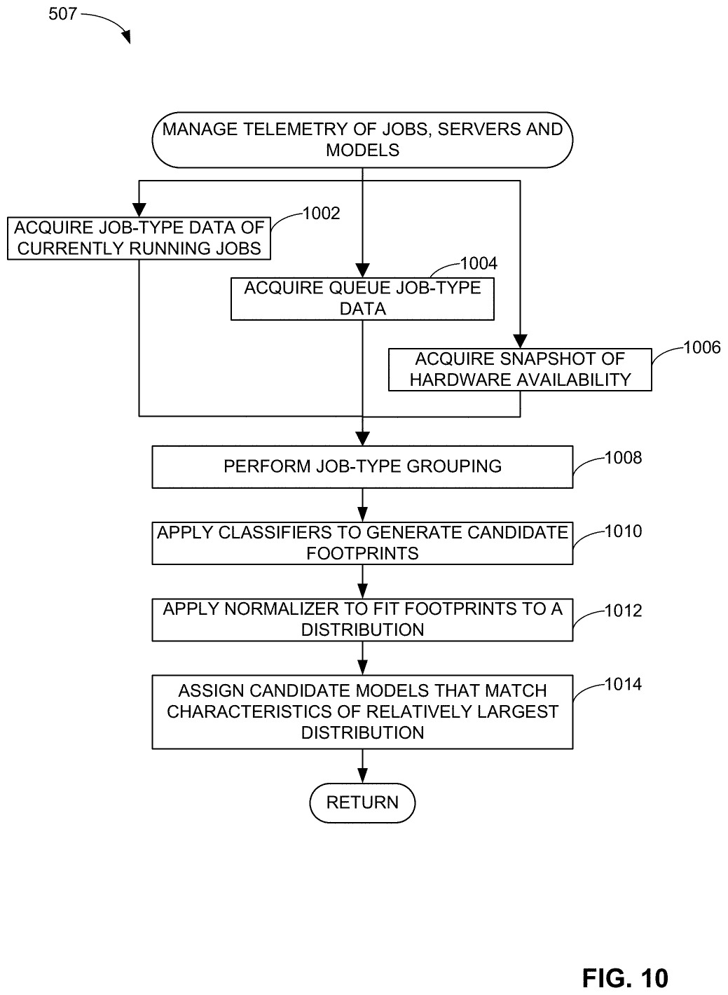

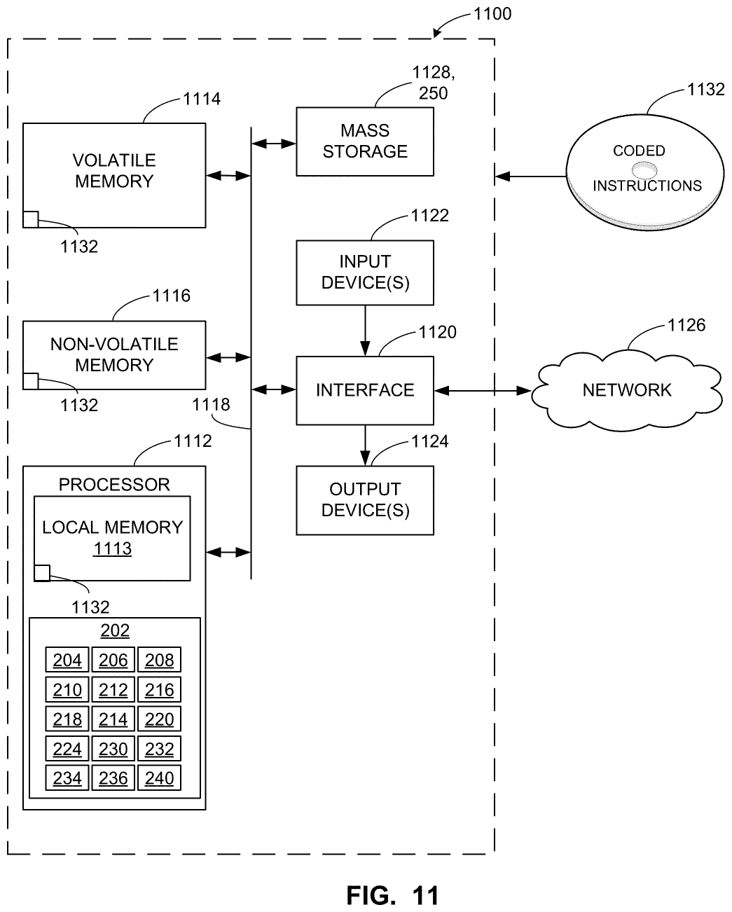

Flowcharts representative of example hardware logic, machine readable instructions, hardware implemented state machines, and/or any combination thereof for implementing the scheduling framework 202 of FIGS. 2A, 2B and 3A are shown in FIGS. 5A1, 5A2, 5A3, 5B, 6A, 6B, 7, 8A-8E, 9 and 10. The machine readable instructions may be one or more executable programs or portion(s) of an executable program for execution by a computer processor such as the processor 812 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 5A1, 5A2, 5A3, 5B, 6A, 6B, 7, 8A-8E, 9 and 10, many other methods of implementing the example scheduling framework 202 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using HyperText Markup Language (HTML) and/or any of the following languages: C, C++, Java, C#, Perl, Python, JavaScript, Structured Query Language (SQL), Swift, etc.

As mentioned above, the example processes of FIGS. 5A1, 5A2, 5A3, 5B, 6A, 6B, 7, 8A-8E, 9, and 10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program 550 of FIG. 5A1 represents a high-level flowchart of the example scheduling framework 202 of FIGS. 2A, 2B, 3A and 4C. The example program 550 may be implemented by the example scheduling framework 202 and/or structure therein. Accordingly, references to the structure of the example scheduling framework 202 is not limiting. In the illustrated example of FIG. 5A1, the scheduling framework 202 submits one or more jobs for processing (block 552), and routes jobs to one or more virtual pools for prioritization (block 554). The example scheduling framework 202 lands job(s) on corresponding server(s) (block 556) and initiates jobs on hardware (block 558). The example scheduling framework 202 determines whether model blending time is zero (block 560) and, if so, performs hardware cluster telemetry (block 562). Otherwise, the example scheduling framework 202 stores data and prepares a binary matrix (block 564).

In the illustrated example of FIG. 5A1, the scheduling framework 202 takes parallel paths when training. In particular, the example scheduling framework 202 initiates training of a regression model (block 566) and training of an LSTM model (block 568). While the illustrated example of FIG. 5A1 includes a discussion of utilizing regression models and LSTM models, such discussion is for example purposes and examples disclosed herein are not limited thereto. Moreover, to the extent regression models and LSTM models are disclosed herein overall, such examples are not limited to regression and/or LSTM model types. The illustrated example of FIG. 5A2 includes further explanation of the example program, in which the example scheduling framework 202 determines whether a regression inference is available (block 570). If so, the example scheduling framework 202 determines whether the training regression has a higher accuracy than a candidate regression model (block 574). If so, then the candidate regression model is promoted (block 572). If not, then predictions occur using the regression candidate model (block 576). However, in the event a regression inference is not available (block 570), then the regression model is promoted to inference (block 572), and prediction occurs using the regression candidate model (block 576).

Prior to performing a comparison regarding which modeling approach (e.g., a regression model approach, which is more computationally expensive than an LSTM model approach) performs in a more accurate manner, the example scheduling framework 202 determines whether an LSTM inference is available (block 578). If so, the example scheduling framework 202 determines if a training LSTM has a higher accuracy than a candidate LSTM model (block 582). If so, then the candidate LSTM model is promoted (block 580), otherwise prediction occurs using an LSTM candidate model (block 584). In the event an LSTM inference is not available (block 578), then the candidate LSTM model is promoted (block 580) and predictions occur using the LSTM candidate model (block 584).

The example scheduling framework 202 compares the regression and LSTM approaches to determine a relatively highest accuracy metric and/or to perform model resilience management (block 586), as described above and in further detail below. The example scheduling framework 202 also determines whether dataset matrix attributes (e.g., attributes from the example dataset matrix of FIGS. 3B through 3E) should be arranged (block 587). If rearrangement should occur (block 587), then control advances to block 590 before returning to block 564 of FIG. 5A1. Generally speaking, rearrangement of the example dataset matrix may be desirable to improve machine learning tasks and increase a degree of diversity in the labelled data that is used for training purposes. As such, dataset matrix rearrangement facilitates model improvements when performing machine learning operations with labelled data. In some examples (e.g., in parallel and/or otherwise independently of dataset matrix rearrangement efforts), jobs are selected using a divide and conquer techniques (e.g., model analysis and greedy algorithm selection techniques (e.g., best fit, knapsack technique(s), etc.) (block 588). Control then returns to FIG. 5A1.

FIG. 8A illustrates additional detail corresponding to the model resilience management of block 586. In the illustrated example of FIG. 8A, the example priority metric manager 230 assesses risk reduction (block 802), the example model accuracy and certainty evaluator 232 assesses accuracy and certainty of models (block 804), the example slack evaluator 234 assesses slack (block 806), and the example model state assessor 236 assesses internal states of models (block 808). While the illustrated example of FIG. 8A shows the aforementioned resilience management operations in series, examples disclosed herein are not limited thereto.

FIG. 8B illustrates additional detail associated with assessing risk reduction of block 802. In the illustrated example of FIG. 8B, the example priority metric manager 230 retrieves priority metrics (block 820). As described above, particular job types may be dynamically assigned different priorities “on the fly.” The example priority metric manager 230 determines whether one or more of the priority metrics has been altered (block 822), such as by comparing one or more metrics to a threshold. In the event changes have occurred, then the priority metric manager 230 adjusts one or more weights of the cost function (block 824), and control returns to block 804 of FIG. 8A.

FIG. 8C illustrates additional detail associated with assessing accuracy and certainty of block 804. In the illustrated example of FIG. 8C, the model accuracy and certainty evaluator 232 selects a model of interest (block 830). In some examples, the model accuracy and certainty evaluator 232 performs a parallel process of calculating model accuracy (block 832) and calculating model certainty (block 834). Results from the aforementioned calculations are applied to the selected model of interest (block 836), which in some examples includes a normalization or aggregation of accuracy and certainty calculations. The example model accuracy and certainty evaluator 232 determines whether additional models of interest are to be evaluated (block 838) and, if so, control returns to block 830. Otherwise the example program 804 of FIG. 8C returns to block 806 of FIG. 8A.

FIG. 8D illustrates additional detail associated with assessing slack of block 806. In the illustrated example of FIG. 8D, the example slack evaluator 234 calculates a quantity of unallocated resources for a time period of interest (block 840), and determines whether one or more jobs are stalled in the queue (block 842). If so, the example slack evaluator 234 allocates slack in view of the stalled job (block 844) and updates and/or otherwise adjusts the cost function to reflect the priority to reserve resources for the selected job (block 846). In some examples, the slack evaluator 234 applies weights in a proportionally increasing manner in the event the particular job of interest waits for a threshold period of time (e.g., the job becomes stale in the queue), thereby allowing the results of the cost function to more aggressively find target resources for the job. Control then returns to block 808 of FIG. 8A.

FIG. 8E illustrates additional detail associated with assessing internal states of block 808. In the illustrated example of FIG. 8E, the model state assessor 236 selects an LSTM model of interest (block 850). However, while the illustrated example of FIG. 8E describes LSTM model analysis, examples disclosed herein are not limited thereto. In some examples any other type of model including two or more layers may be analyzed in a similar manner. The example model state assessor 236 selects one of the model layers (block 852), calculates a probability of the selected layer (block 854), and determines whether the probability value satisfies a threshold (block 856). In some examples, the threshold is referred to as a “cull” threshold such that when the cull threshold is satisfied (block 856), the particular layer under analysis is identified for culling, removal or deactivation (block 858). However, in the event the culling threshold is not satisfied (block 856), the particular layer under analysis is retained (block 860). The example model state assessor 236 determines whether there are additional layers to analyze (block 862) and, if so, control returns to block 852. Otherwise, the model state assessor 236 determines whether there are additional models to be analyzed (block 864) and, if so, control returns to block 850. Otherwise control returns to block 587 of FIG. 5A2.

FIG. 5A3 illustrates additional detail corresponding to the rearrangement of attributes (block 590). In the illustrated example of FIG. 5A3, the example model evaluator 212 imports default dataset matrix attributes and creates a separate instance of LSTM models and/or regression models (block 591). For example, the dataset matrix may have thirty-five attributes (e.g., number of jobs in queue, number of available devices, etc.). The example model evaluator 212 determines whether these attributes have been used to train a model of interest (block 592) and, if not, trains the model (block 594). The example model evaluator 212 may perform iterative training efforts using the current set of attributes for a training threshold. The example training threshold includes, but is not limited to a threshold number of training iterations using the current set of attributes, a threshold period of time, a threshold number of training epochs, etc. Training rates are stored (block 595) and the example model evaluator 212 determines whether a time interval has ended (block 596). If not, then control returns to block 591.

Returning to example block 592, in the event that the model has already once been trained with the existing dataset matrix features, the model evaluator 212 selects a different combination of attributes (block 593). For instance, sometimes regression and/or LSTM models do not produce a highest relative accuracy prediction using the default set of attributes. In view of this possibility, different combinations of attributes are selected as a subset of the total number of attributes available in the default set. In some examples, different attributes and/or quantities of those different attributes are selected by the model evaluator 212 to be evaluated. Corresponding accuracy rates are stored, as disclosed above in connection with block 595. In some examples, the model evaluator 212 invokes the example rearrangement operations of the program (block 590) based on a threshold initial accuracy value (e.g., accuracy values lower than 40% cause the rearrangement operations to be invoked). In some examples, the rearrangement operations may be initiated based on analyst discretion.

FIG. 9 illustrates additional detail associated with selecting jobs of block 588. In the illustrated example of FIG. 9, the example model builder 210 acquires a list of models (block 902) and selects one for further evaluation (block 904). The example model accuracy and certainty evaluator 232 calculates one or more prediction valuation metrics (block 906) and determines whether one or more thresholds are satisfied (block 908). If the one or more thresholds are not satisfied (block 908), the example model builder 210 selects an alternate model (block 910) and control returns to block 904. Otherwise, the example optimizer 214 retains the model to be used for resource prediction and building a job queue (block 912). The example model builder 210 determines whether more models are to be analyzed (block 914) and, if so, control returns to block 904.

When all models of interest have been analyzed (e.g., analyzed for an iteration of interest, such as a time period of interest) (block 914), the example data retriever 204 retrieves job priority characteristics (block 916). The example classifier manager 240 applies one or more greedy algorithms to an objective function, such as a cost function (block 918). As described above, the greedy algorithms may include, but are not limited to a largest best fit algorithm, a smallest best fit algorithm, or a knapsack algorithm. The example optimizer 214 assigns job queues to corresponding optimization algorithms based on the cost function and corresponding job characteristics (block 920), which is shown graphically in the illustrated example of FIG. 4C.

In some example operations of the example scheduling framework 202, addresses circumstances when numerous inputs and/or numerous model selection options can inundate a user and/or inundate computational capabilities of the example framework 202. To address such circumstances, the program 500 of FIG. 5B includes block 502 where the example data retriever 204 retrieves data from the example data store 250. The example architecture analyzer 206 retrieves, receives and/or otherwise determines a target hardware map (block 504), and the example matrix generator 208 designs a dataset matrix (block 506). To handle or otherwise efficiently manage large volumes of input telemetry and associate particular jobs with particular models that can best predict resource utilization, the example scheduling framework 202 performs management of telemetry of jobs, servers and models (block 507). Further details corresponding to management of telemetry of jobs, servers and models is described in further detail in connection with FIG. 10. The example architecture analyzer 206 selects a resource to be predicted (e.g., a percentage likelihood that the resource is consumed or available) (block 508), and the example model builder 210 loads a subset of data to an LSTM model (block 510) and loads a subset of data to a polynomial regression model (block 512). The example architecture analyzer 206 determines whether there are additional resources to analyze (e.g., any number of individual processors, processor cores, emulators, etc.) (block 514). If so, then control returns to block 508. Otherwise, the example model evaluator 212 evaluates any number of models to generate prediction metrics (block 516), as discussed in further detail in FIGS. 6A and 6B. The example optimizer 214 applies one or more optimization algorithms using the prediction metrics (block 518), as discussed in further detail in FIG. 7.

FIG. 6A illustrates additional detail in connection with evaluating models to generate prediction metrics (block 516 of FIG. 5B). In the illustrated example of FIG. 6A, the example feature generator 216 imports linear regression and polynomial features (block 602). In some examples, the imported features are default features utilized prior to the accumulation of historical training and/or modeling data that occurs through any number of system epochs. While examples disclosed herein refer to a first model type as one or more polynomial regression models and a second model type as one or more LSTM models, examples are not limited thereto. A polynomial complexity degree may be set (by the feature generator 216) to different values (block 604) to improve an accuracy rate of the polynomial model. In some examples, a default complexity characteristic (e.g., a complexity degree value of the polynomial) is set by the example feature generator 216. For instance, a first iteration of the example flowchart of block 516 may set a default polynomial complexity value to a degree of “2.” However, such complexity setting increases tend to cause a greater degree of computational resources to be consumed by the scheduling framework 202 when generating predictive metrics of resource utilization. Examples disclosed herein assist in setting values of the polynomial complexity settings in view of, for example, different quantities of historical data that can be used with LSTM modeling, which could effectively reduce a reliance upon polynomial regression techniques when making predictions. Generally speaking, when a modeling effort initially begins there is no historical data to rely upon, thereby hindering the use of LSTM models and requiring reliance upon polynomial models. To adjust and/or otherwise determine a complexity degree setting of the polynomial model(s), the example label trainer 218 fits a transform dataset (block 606) and trains corresponding labels (block 608). The example model evaluator 212 generates corresponding prediction values using the (polynomial) linear regression (block 610) and determines if the prediction value accuracy satisfies one or more threshold values (block 612). If not, then control returns to block 606 to retrain the model after first incrementing a degree of complexity of the polynomial model (block 613) during a subsequent iteration. However, in the event the model evaluator 212 determines that the prediction value accuracy satisfies one or more threshold values (block 612), then the model evaluator 212 saves the trained model (block 614) (e.g., saved to the example data store 250).

The illustrated example of FIG. 6A performs its first iteration under the assumption or expectation that there is no historical data available that would otherwise be beneficial for LSTM modeling approaches. As such, initial passes through the illustrated example of FIG. 6A will rely entirely upon polynomial regression modeling techniques of different degrees of complexity. During the initial iteration of the example program 516 of FIG. 6A, the model evaluator 212 sets a polynomial activation weight value to one (e.g., 1.0) to indicate that predictions should occur exclusively by polynomial regression modeling approaches, and prevents utilization of any other model type (e.g., LSTM). The example polynomial activation weight is a value between zero (0.0) and one (1.0) to represent a proportional amount of prediction calculations should be performed by either polynomial models, LSTM models, or any combination thereof. Values of one (1.0) represent circumstances where 100% of the prediction efforts are to occur with polynomial models, values of zero (0.0) represent circumstances where 100% of the prediction efforts are to occur with LSTM models, and values of 0.5 represent circumstances where 50% of the prediction efforts occur with polynomial models and 50% of the prediction efforts occur with LSTM models.

To establish, update and/or otherwise determine a balance between prediction efforts via polynomial models and LSTM models, the example model builder 210 assesses LSTM participation metrics (block 616). FIG. 6B illustrates additional detail associated with assessing LSTM participation of block 616. In the illustrated example of FIG. 6B, the example data retriever 204 determines whether historical data is available (block 620). Historical data includes, but is not limited to, historical model training data or historical job-mapping data (e.g., instances of mapping particular jobs to particular hardware resources). The data retriever 204 may determine available historical data by evaluating time stamps of collected data to confirm whether they correspond to a recent prediction effort associated with particular hardware resources. In the event there are no corresponding date/time stamped data points corresponding to a time period of interest, or particular target hardware resources of interest (e.g., data stored in the example data store 250), the model builder 210 maintains a current polynomial model activation weight value (block 621) and the program 616 of FIG. 6B exits and prediction efforts continue to rely on polynomial regression models.

On the other hand, the example data retriever 204 identifies historical data is available (block 620), the example model builder 210 further evaluates those available historical data points to determine a sufficiency metric (block 622). Example sufficiency metrics may include, but are not limited to a threshold number of relevant data points, a threshold period of time with which a current prediction effort lasts, or a number of training epochs of the example scheduling framework 202. The example sufficiency metrics may be tiered, such that two or more thresholds correspond to two or more polynomial activation weight values. For instance, a first threshold number of relevant data points may be 10,000, which corresponds to a polynomial activation weight of 0.80 (e.g., 80% of the prediction efforts utilize polynomial models and 20% of the prediction efforts utilize LSTM models). However, as the example sufficiency metrics improve and/or otherwise increase (e.g., relevant data points increase to 20,000), the polynomial activation weight may be adjusted to 0.60 to reflect the relative increase in historical data that is helpful for LSTM modeling approaches.

The example model builder 210 sets and/or otherwise updates the polynomial activation weight based on the calculated sufficiency metrics (block 624). In some examples, the model builder 210 adjusts and/or otherwise reduces a degree of the complexity factor of the polynomial models (block 626). Reducing the degree of the complexity factor serves to also reduce computational burdens of the example scheduling system 200 when historical data is available for LSTM modeling approaches. The example program 616 then exits.

FIG. 7 illustrates additional detail in connection with applying optimization (block 518 of FIG. 5B). In the illustrated example of FIG. 7, the example data retriever 204 obtains inputs (block 702), and the example key evaluator 220 initiates a loop in which the loop begins with the job size in reverse order (block 704). The example key evaluator 220 verifies, as the beginning portion of the loop (block 704), whether all keys have been considered (block 706). If so, then one or more iterations of the example loop (block 704) have likely occurred and the example process of block 518 returns. If not all keys have been considered (block 706), the example key evaluator 220 determines whether a selected key is empty (block 708) and, if so, a next key is selected (block 710) and control returns to block 704. However, if the key is not empty (block 708), then the example architecture analyzer 206 determines whether the number of available resources is zero (block 712). If so, then the example process of block 518 returns as all resources have been analyzed.

In the event there are remaining resources to evaluate (block 712), then the example key evaluator 220 initiates a sub-loop to advance through job IDs for the selected key (block 714). The example job size evaluator 224 determines whether a current job size is less than or equal to a number of available resources (block 716) and, if so, the example job size evaluator 224 appends a job ID (block 718), removes the appended job ID from a list (block 720), and decrements a tracked job size value (block 722). If the example job size evaluator 224 determines that a current job size value is greater than or equal to a number of available resources (block 724), then the example key evaluator 220 selects a next key (block 710), otherwise the example key evaluator 220 selects a next job ID in the list (block 726). While the illustrated example of FIG. 7 includes a loop-based approach, examples disclosed herein are not limited thereto. In some examples, optimization efforts may occur by way of recursion. For instance, in some examples the recursion approach may proceed in view of one or more conditional statements to break the optimization effort(s).

Returning to block 507 of FIG. 5B, FIG. 10 illustrates additional detail associated with managing telemetry of jobs, servers and models. In the illustrated example of FIG. 10, the example data retriever 204 acquires (a) job-type data of currently running jobs (on hardware resources) (block 1002), (b) job-type data of jobs not yet assigned to hardware resources, but in one or more queues (block 1004), and (c) current hardware availability metrics (block 1006) (e.g., a quantity of available hardware resources, whether such resources are continuous, resource types, etc.). The example job evaluator 224 performs job-type grouping (block 1008) based on any type of desired characteristic, such as job-types that require a specific number of processing cores, job-types that require physically adjacent hardware resources interconnected with particular bus bandwidth capabilities, etc. The example classifier manager 240 applies one or more classification algorithms (block 1010) (e.g., a decision tree, permutation tree, etc.) to generate candidate footprints, and applies a normalizer to fit the footprints to a distribution (block 1012). In some examples, the normalizer is a fit transform function, such as example SciKit-learn® algorithms. The example optimizer 214 then assigns candidate models that match characteristics of a largest portion of the distribution (block 1014), thereby matching particular jobs with the models most likely to exhibit optimized prediction metrics.

FIG. 11 is a block diagram of an example processor platform 1100 structured to execute the instructions of FIGS. 5A1, 5A2, 5A3, 5B, 6A, 6B, 7, 8A-8E, 9 and 10 to implement the scheduling framework 202 of FIGS. 2A, 2B, 3A and 4C. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example data retriever 204, the example architecture analyzer 206, the example matrix generator 208, the example model builder 210, the example model evaluator 212, the example feature generator 216, the example label trainer 218, the example priority metric manager 230, the example model accuracy and certainty evaluator 232, the example slack evaluator 234, the example model state assessor 236, the example optimizer 214, the example key evaluator 220, the example job evaluator 224, the example classifier manager 240 and, the example scheduling framework 202.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIGS. 5A1, 5A2, 5A3, 5B, 6A, 6B, 7, 8A-8E, 9 and 10 may be stored in the mass storage device 1128, in the volatile memory 1114, in the non-volatile memory 1116, and/or on a removable non-transitory computer readable storage medium such as a CD or DVD.

While examples disclosed above may be realized in an edge-cloud environment, and FIG. 11 illustrates an example processing platform 1100 on which certain examples can be implemented, certain examples can be implemented in other cloud/edge environments with other processing configurations.

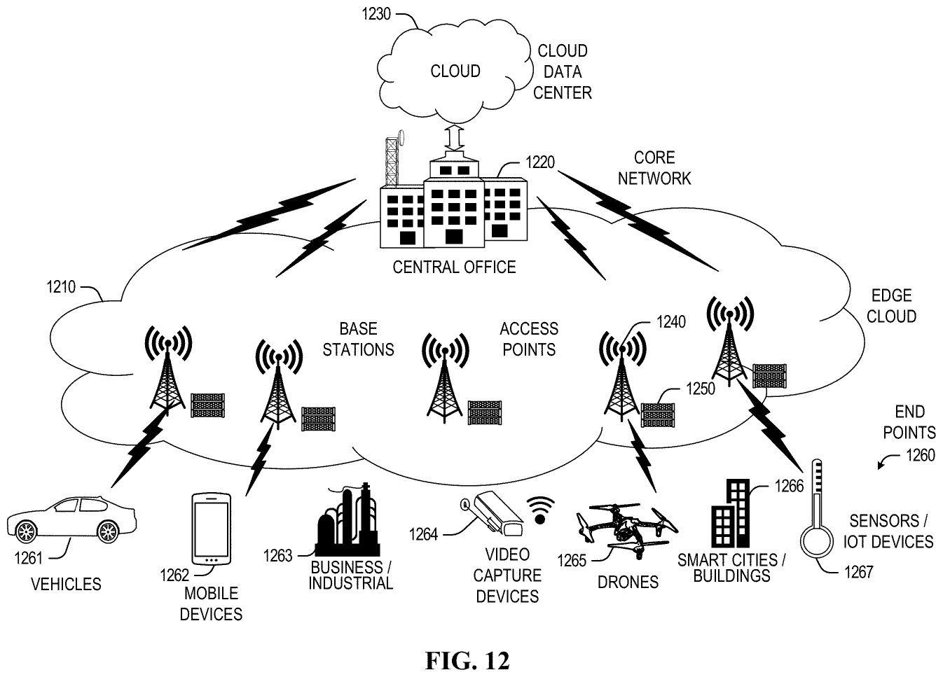

FIG. 12 is a block diagram 1200 showing an overview of another configuration for edge computing, which includes a layer of processing referred to in many of the following examples as an “edge cloud”. As shown, the edge cloud 1210 is co-located at an edge location, such as an access point or base station 1240, a local processing hub 1250, or a central office 1220, and, thus, may include multiple entities, devices, and equipment instances. The edge cloud 1210 is located much closer to the endpoint (consumer and producer) data sources 1260 (e.g., autonomous vehicles 1261, user equipment 1262, business and industrial equipment 1263, video capture devices 1264, drones 1265, smart cities and building devices 1266, sensors and IoT devices 1267, etc.) than the cloud data center 1230. Compute, memory, and storage resources which are offered at the edges in the edge cloud 1210, are critical to providing ultra-low latency response times for services and functions used by the endpoint data sources 1260 as well as reduce network backhaul traffic from the edge cloud 1210 toward cloud data center 1230, thus improving energy consumption and overall network usage, among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., UEs), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data (e.g., at a “local edge”, “close edge”, or “near edge”). For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

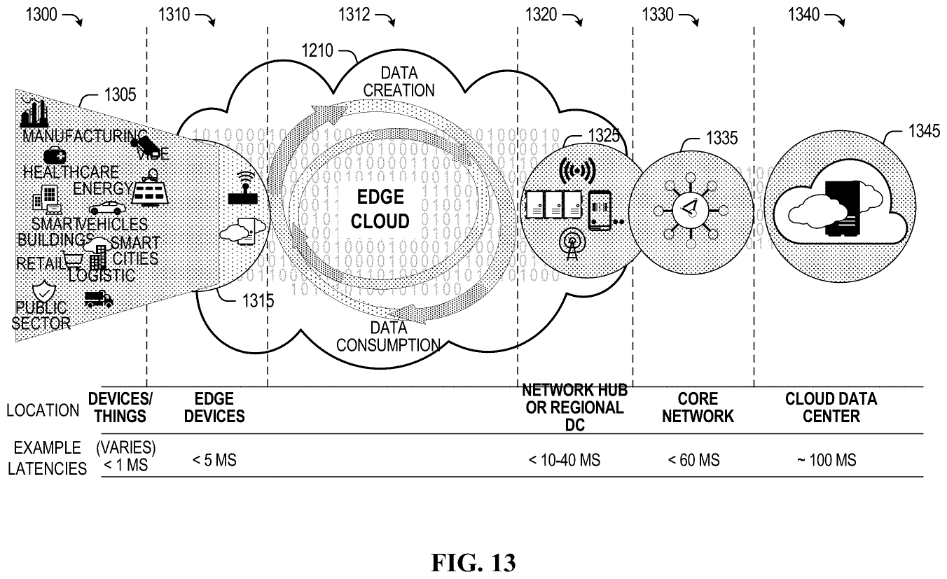

FIG. 13 illustrates operational layers among endpoints, an edge cloud, and cloud computing environments. Specifically, FIG. 13 depicts examples of computational use cases 1305, utilizing the edge cloud 1210 among multiple illustrative layers of network computing. The layers begin at an endpoint (devices and things) layer 1300, which accesses the edge cloud 1210 to conduct data creation, analysis, and data consumption activities. The edge cloud 1210 may span multiple network layers, such as an edge devices layer 1310 having gateways, on-premise servers, or network equipment (nodes 1315) located in physically proximate edge systems; a network access layer 1320, encompassing base stations, radio processing units, network hubs, regional data centers, or local network equipment (equipment 1325); and any equipment, devices, or nodes located therebetween (in layer 1312, not illustrated in detail). The network communications within the edge cloud 1210 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1300, under 5 ms at the edge devices layer 1310 (e.g., a “near edge” or “close edge” layer), to even between 10 to 40 ms when communicating with nodes at the network access layer 1320 (e.g., a “middle edge” layer). Beyond the edge cloud 1210 are core network 1330 and cloud data center 1340 layers, each with increasing latency (e.g., between 50-60 ms at the core network layer 1330, to 100 or more ms at the cloud data center layer, both of which may be considered a “far edge” layer). As a result, operations at a core network data center 1335 or a cloud data center 1345, with latencies of at least 50 to 100 ms or more, will not be able to accomplish many time-critical functions of the use cases 1305. Each of these latency values are provided for purposes of illustration and contrast; it will be understood that the use of other access network mediums and technologies may further reduce the latencies.

The various use cases 1305 may access resources under usage pressure from incoming streams, due to multiple services utilizing the edge cloud. To achieve results with low latency, the services executed within the edge cloud 1210 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation and (2) augment other components in the system to resume overall transaction SLA and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.) which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 1210 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1210 (network layers 1300-1340), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or slave role; rather, any of the nodes or devices in the edge computing system refer to individual entities, nodes, or subsystems which include discrete or connected hardware or software configurations to facilitate or use the edge cloud 1210.

As such, the edge cloud 1210 is formed from network components and functional features operated by and within edge gateway nodes, edge aggregation nodes, or other edge compute nodes among network layers 1310-1330. The edge cloud 1210 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

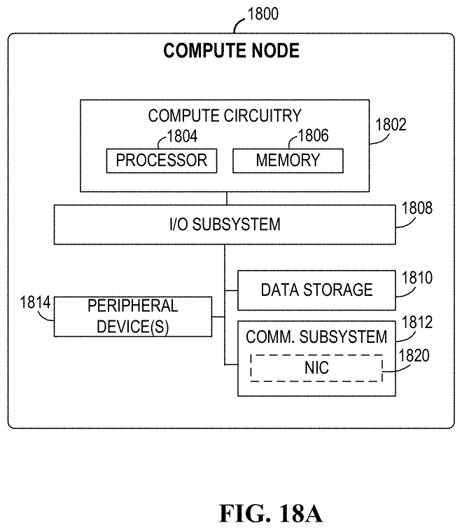

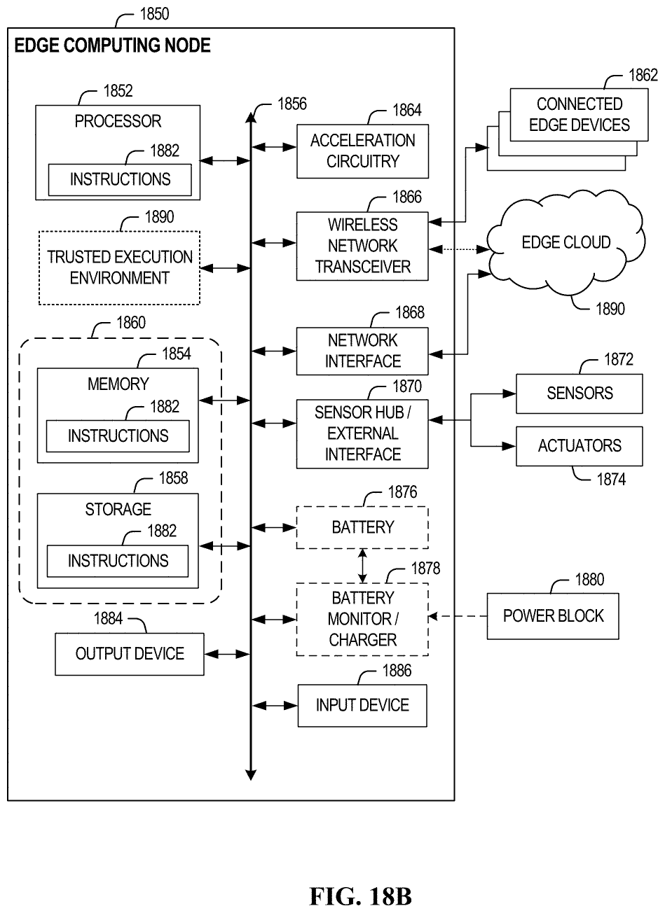

The network components of the edge cloud 1210 may be servers, multi-tenant servers, appliance computing devices, and/or any other type of computing devices. For example, the edge cloud 1210 may be an appliance computing device that is a self-contained processing system including a housing, case, or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 18B. The edge cloud 1210 may also include one or more server and/or one or more multi-tenant server. Such a server may implement a virtual computing environment such as a hypervisor for deploying virtual machines, an operating system that implements containers, etc. Such virtual computing environments provide an execution environment in which one or more applications may execute while being isolated from one or more other applications.

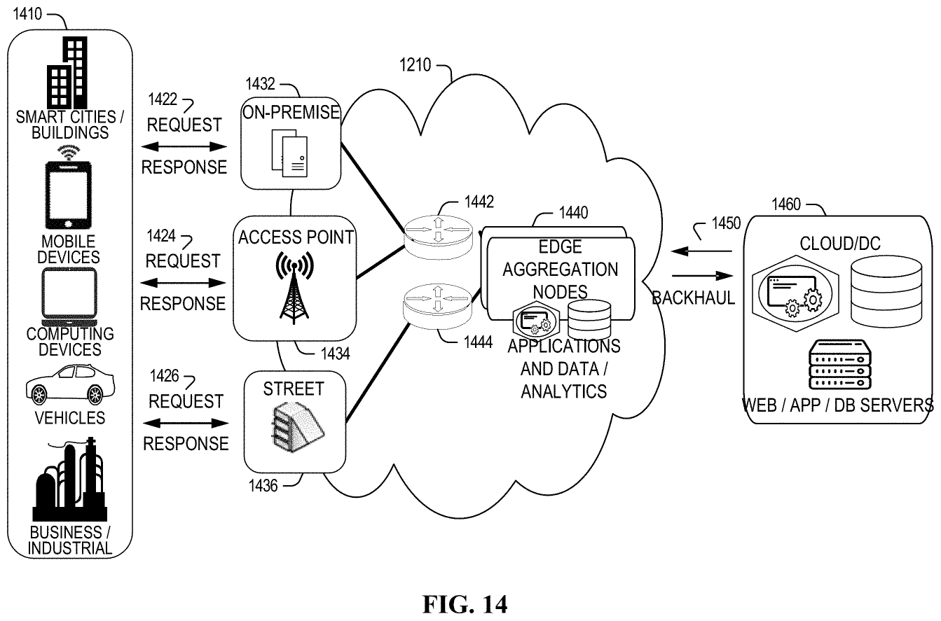

In FIG. 14, various client endpoints 1410 (in the form of mobile devices, computers, autonomous vehicles, business computing equipment, industrial processing equipment) exchange requests and responses that are specific to the type of endpoint network aggregation. For instance, computers, business computing equipment, and industrial processing equipment may obtain network access via a wired broadband network, by exchanging requests and responses 1422 through an on-premise network system 1432. Mobile computing devices may obtain network access via a wireless broadband network, by exchanging requests and responses 1424 through a cellular network tower 1434. Autonomous vehicles may obtain network access for requests and responses 1426 via a wireless vehicular network through a street-located network system 1436. However, regardless of the type of network access, the TSP may deploy aggregation points 1442, 1444 within the edge cloud 1210 to aggregate traffic and requests. Thus, within the edge cloud 1210, the TSP may deploy various compute and storage resources, such as at edge aggregation nodes 1440, to provide requested content. The edge aggregation nodes 1440 and other systems of the edge cloud 1210 are connected to a cloud or data center 1460, which uses a backhaul network 1450 to fulfill higher-latency requests from a cloud/data center for websites, applications, database servers, etc. (Additional or consolidated instances of the edge aggregation nodes 1440 and the aggregation points 1442, 1444, including those deployed on a single server framework, may also be present within the edge cloud 1210 or other areas of the TSP infrastructure).

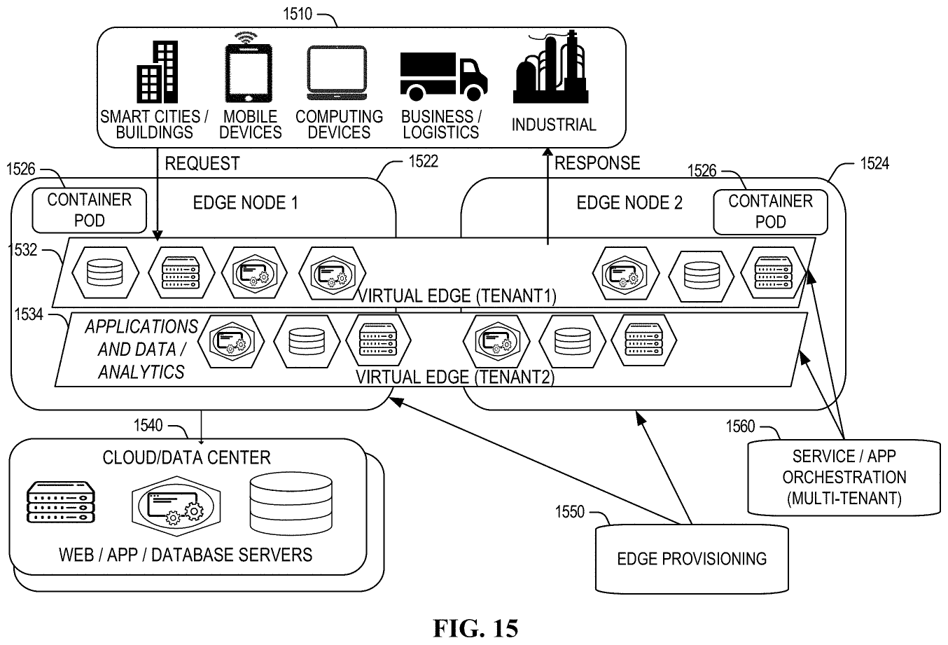

FIG. 15 illustrates deployment and orchestration for virtual edge configurations across an edge computing system operated among multiple edge nodes and multiple tenants. Specifically, FIG. 15 depicts coordination of a first edge node 1522 and a second edge node 1524 in an edge computing system 1500, to fulfill requests and responses for various client endpoints 1510 (e.g., smart cities/building systems, mobile devices, computing devices, business/logistics systems, industrial systems, etc.) which access various virtual edge instances. Here, the virtual edge instances provide edge compute capabilities and processing in an edge cloud, with access to a cloud/data center 1540 for higher-latency requests for websites, applications, database servers, etc. However, the edge cloud enables coordination of processing among multiple edge nodes for multiple tenants or entities.

In the example of FIG. 15, these virtual edge instances include: a first virtual edge 1532, offered to a first tenant (Tenant 1), which offers a first combination of edge storage, computing, and services; and a second virtual edge 1534, offering a second combination of edge storage, computing, and services. The virtual edge instances 1532, 1534 are distributed among the edge nodes 1522, 1524, and may include scenarios in which a request and response are fulfilled from the same or different edge nodes. The configuration of the edge nodes 1522, 1524 to operate in a distributed yet coordinated fashion occurs based on edge provisioning functions 1550. The functionality of the edge nodes 1522, 1524 to provide coordinated operation for applications and services, among multiple tenants, occurs based on orchestration functions 1560.

It should be understood that some of the devices in 1510 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 1522, 1524 may operate as security feature enforcement points for local resources allocated to multiple tenants per node. Additionally, tenant runtime and application execution (e.g., in instances 1532, 1534) may serve as an enforcement point for a security feature that creates a virtual edge abstraction of resources spanning potentially multiple physical hosting platforms. Finally, the orchestration functions 1560 at an orchestration entity may operate as a security feature enforcement point for marshalling resources along tenant boundaries.

Edge computing nodes may partition resources (memory, CPU, GPU, interrupt controller, I/O controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 1510, 1522, and 1540 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 15. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 1522, 1524 may implement the use of containers, such as with the use of a container “pod” 1526, 1528 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 1532, 1534 are partitioned according to the needs of each container.

With the use of container pods, a pod controller oversees the partitioning and allocation of containers and resources. The pod controller receives instructions from an orchestrator (e.g., orchestrator 1560) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 1560 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

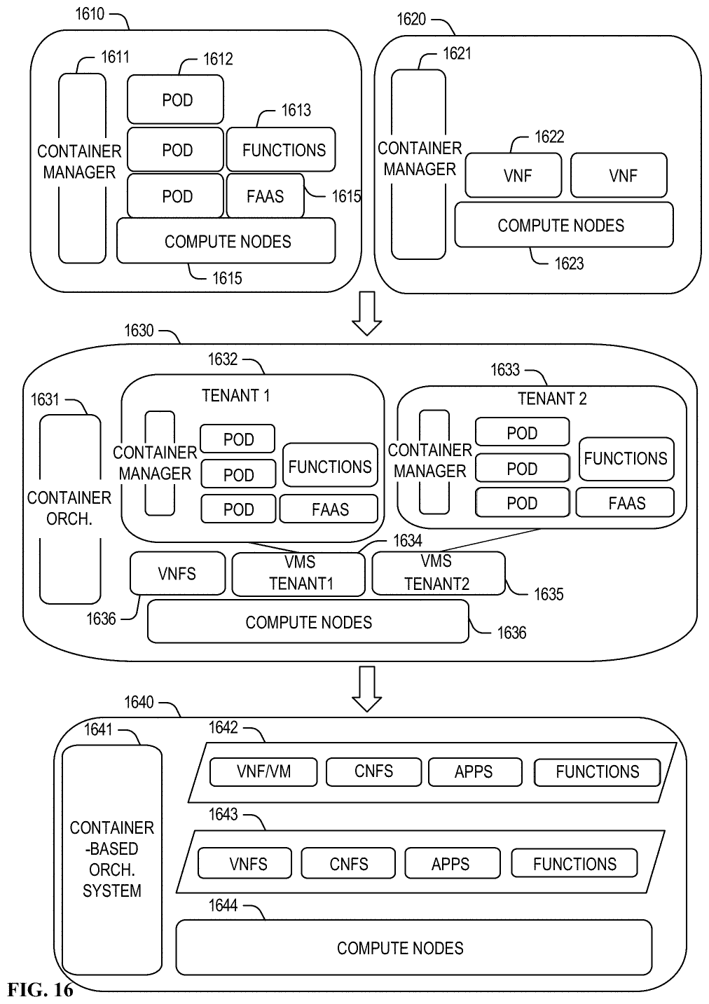

FIG. 16 illustrates additional compute arrangements deploying containers in an edge computing system. As a simplified example, system arrangements 1610, 1620 depict settings in which a pod controller (e.g., container managers 1611, 1621, 1631) is adapted to launch containerized pods, functions, and functions-as-a-service instances through execution via compute nodes (1615 in arrangement 1610), or to separately execute containerized virtualized network functions through execution via compute nodes (1623 in arrangement 1620). This arrangement is adapted for use of multiple tenants in system arrangement 1630 (using compute nodes 1636), where containerized pods (e.g., pods 1612), functions (e.g., functions 1613, VNFs 1622, 1636), and functions-as-a-service instances (e.g., FaaS instance 1615) are launched within virtual machines (e.g., VMs 1634, 1635 for tenants 1632, 1633) specific to respective tenants (aside the execution of virtualized network functions). This arrangement is further adapted for use in system arrangement 1640, which provides containers 1642, 1643, or execution of the various functions, applications, and functions on compute nodes 1644, as coordinated by a container-based orchestration system 1641.

The system arrangements of depicted in FIG. 16 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 16, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

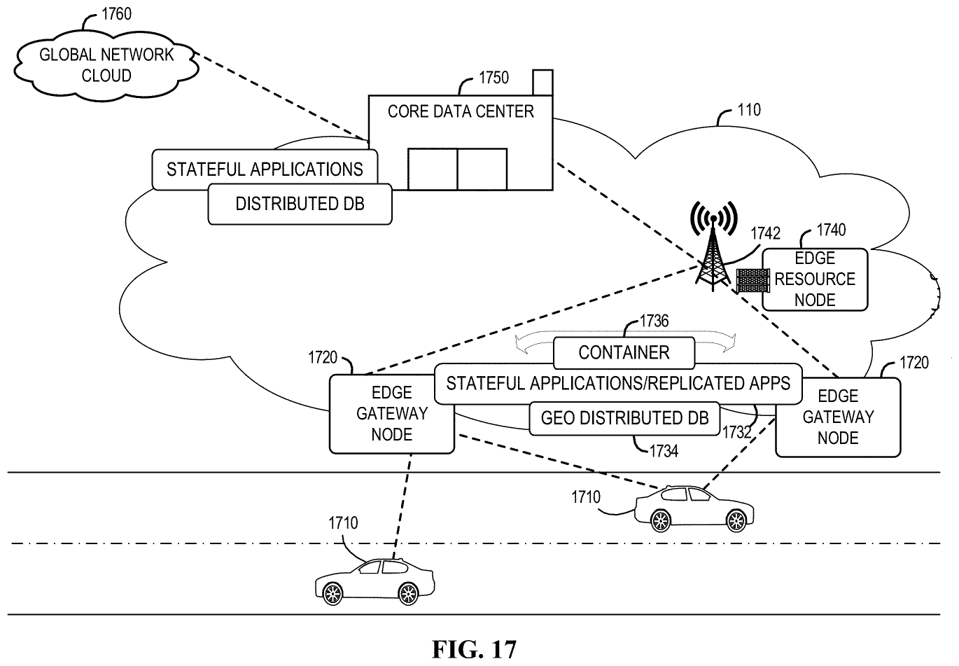

It should be appreciated that the edge computing systems and arrangements discussed herein may be applicable in various solutions, services, and/or use cases involving mobility. As an example, FIG. 17 shows a simplified vehicle compute and communication use case involving mobile access to applications in an edge computing system 1700 that implements an edge cloud 1210. In this use case, respective client compute nodes 1710 may be embodied as in-vehicle compute systems (e.g., in-vehicle navigation and/or infotainment systems) located in corresponding vehicles which communicate with the edge gateway nodes 1720 during traversal of a roadway. For instance, the edge gateway nodes 1720 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 1710 and a particular edge gateway device 1720 may propagate so as to maintain a consistent connection and context for the client compute node 1710. Likewise, mobile edge nodes may aggregate at the high priority services or according to the throughput or latency resolution requirements for the underlying service(s) (e.g., in the case of drones). The respective edge gateway devices 1720 include an amount of processing and storage capabilities and, as such, some processing and/or storage of data for the client compute nodes 1710 may be performed on one or more of the edge gateway devices 1720.

The edge gateway devices 1720 may communicate with one or more edge resource nodes 1740, which are illustratively embodied as compute servers, appliances or components located at or in a communication base station 1742 (e.g., a based station of a cellular network). As discussed above, the respective edge resource nodes 1740 include an amount of processing and storage capabilities and, as such, some processing and/or storage of data for the client compute nodes 1710 may be performed on the edge resource node 1740. For example, the processing of data that is less urgent or important may be performed by the edge resource node 1740, while the processing of data that is of a higher urgency or importance may be performed by the edge gateway devices 1720 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 1740 also communicate with the core data center 1750, which may include compute servers, appliances, and/or other components located in a central location (e.g., a central office of a cellular communication network). The core data center 1750 may provide a gateway to the global network cloud 1760 (e.g., the Internet) for the edge cloud 1210 operations formed by the edge resource node(s) 1740 and the edge gateway devices 1720. Additionally, in some examples, the core data center 1750 may include an amount of processing and storage capabilities and, as such, some processing and/or storage of data for the client compute devices may be performed on the core data center 1750 (e.g., processing of low urgency or importance, or high complexity).

The edge gateway nodes 1720 or the edge resource nodes 1740 may offer the use of stateful applications 1732 and a geographic distributed database 1734. Although the applications 1732 and database 1734 are illustrated as being horizontally distributed at a layer of the edge cloud, it will be understood that resources, services, or other components of the application may be vertically distributed throughout the edge cloud (including, part of the application executed at the client compute node 1710, other parts at the edge gateway nodes 1720 or the edge resource nodes 1740, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 1736 (or pod of containers) may be flexibly migrated from an edge node 1720 to other edge nodes (e.g., 1720, 1740, 1750, 1760, etc.) such that the container with an application and workload does not need to be reconstituted, re-compiled, re-interpreted in order for migration to work. However, in such settings, there may be some remedial or “swizzling” translation operations applied. For example, the physical hardware at node 1740 may differ from 1720 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format or may involve mapping interfaces and operations. A pod controller may be used to drive the interface mapping as part of the container lifecycle, which includes migration to/from different hardware environments.

The scenarios encompassed by FIG. 17 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 1720, some others at the edge resource node 1740, and others in the core data center 1750 or global network cloud 1760.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

In further examples, any of the compute nodes or devices discussed with reference to the present edge computing systems and environment may be fulfilled based on the components depicted in FIGS. 18A and 18B. Respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 18A, an edge compute node 1800 includes a compute engine (also referred to herein as “compute circuitry”) 1802, an input/output (I/O) subsystem 1808, data storage 1810, a communication circuitry subsystem 1812, and, optionally, one or more peripheral devices 1814. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1800 may be embodied as any type of engine, device, or collection of devices capable of performing various compute functions. In some examples, the compute node 1800 may be embodied as a single device such as an integrated circuit, an embedded system, a field-programmable gate array (FPGA), a system-on-a-chip (SOC), or other integrated system or device. In the illustrative example, the compute node 1800 includes or is embodied as a processor 1804 and a memory 1806. The processor 1804 may be embodied as any type of processor capable of performing the functions described herein (e.g., executing an application). For example, the processor 1804 may be embodied as a multi-core processor(s), a microcontroller, or other processor or processing/controlling circuit. In some examples, the processor 1804 may be embodied as, include, or be coupled to an FPGA, an application specific integrated circuit (ASIC), reconfigurable hardware or hardware circuitry, or other specialized hardware to facilitate performance of the functions described herein.

The main memory 1806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the main memory 1806 may be integrated into the processor 1804. The main memory 1806 may store various software and data used during operation such as one or more applications, data operated on by the application(s), libraries, and drivers.

The compute circuitry 1802 is communicatively coupled to other components of the compute node 1800 via the I/O subsystem 1808, which may be embodied as circuitry and/or components to facilitate input/output operations with the compute circuitry 1802 (e.g., with the processor 1804 and/or the main memory 1806) and other components of the compute circuitry 1802. For example, the I/O subsystem 1808 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1808 may form a portion of a system-on-a-chip (SoC) and be incorporated, along with one or more of the processor 1804, the main memory 1806, and other components of the compute circuitry 1802, into the compute circuitry 1802.

The one or more illustrative data storage devices 1810 may be embodied as any type of devices configured for short-term or long-term storage of data such as, for example, memory devices and circuits, memory cards, hard disk drives, solid-state drives, or other data storage devices. Individual data storage devices 1810 may include a system partition that stores data and firmware code for the data storage device 1810. Individual data storage devices 1810 may also include one or more operating system partitions that store data files and executables for operating systems depending on, for example, the type of compute node 1800.

The communication circuitry 1812 may be embodied as any communication circuit, device, or collection thereof, capable of enabling communications over a network between the compute circuitry 1802 and another compute device (e.g., an edge gateway of an implementing edge computing system). The communication circuitry 1812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1812 includes a network interface controller (NIC) 1820, which may also be referred to as a host fabric interface (HFI). The NIC 1820 may be embodied as one or more add-in-boards, daughter cards, network interface cards, controller chips, chipsets, or other devices that may be used by the compute node 1800 to connect with another compute device (e.g., an edge gateway node). In some examples, the NIC 1820 may be embodied as part of a system-on-a-chip (SoC) that includes one or more processors or included on a multichip package that also contains one or more processors. In some examples, the NIC 1820 may include a local processor (not shown) and/or a local memory (not shown) that are both local to the NIC 1820. In such examples, the local processor of the NIC 1820 may be capable of performing one or more of the functions of the compute circuitry 1802 described herein. Additionally, or alternatively, in such examples, the local memory of the NIC 1820 may be integrated into one or more components of the client compute node at the board level, socket level, chip level, and/or other levels.

Additionally, in some examples, a respective compute node 1800 may include one or more peripheral devices 1814. Such peripheral devices 1814 may include any type of peripheral device found in a compute device or server such as audio input devices, a display, other input/output devices, interface devices, and/or other peripheral devices, depending on the particular type of the compute node 1800. In further examples, the compute node 1800 may be embodied by a respective edge compute node (whether a client, gateway, or aggregation node) in an edge computing system or like forms of appliances, computers, subsystems, circuitry, or other components.

In a more detailed example, FIG. 18B illustrates a block diagram of an example of components that may be present in an edge computing node 1850 for implementing the techniques (e.g., operations, processes, methods, and methodologies) described herein. This edge computing node 1850 provides a closer view of the respective components of node 1800 when implemented as or as part of a computing device (e.g., as a mobile device, a base station, server, gateway, etc.). The edge computing node 1850 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the edge computing node 1850, or as components otherwise incorporated within a chassis of a larger system.

The edge computing device 1850 may include processing circuitry in the form of a processor 1852, which may be a microprocessor, a multi-core processor, a multithreaded processor, an ultra-low voltage processor, an embedded processor, or other known processing elements. The processor 1852 may be a part of a system on a chip (SoC) in which the processor 1852 and other components are formed into a single integrated circuit, or a single package, such as the Edison™ or Galileo™ SoC boards from Intel Corporation, Santa Clara, Calif. As an example, the processor 1852 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1852 and accompanying circuitry may be provided in a single socket form factor, multiple socket form factor, or a variety of other formats, including in limited hardware configurations or configurations that include fewer than all elements shown in FIG. 18.

The processor 1852 may communicate with a system memory 1854 over an interconnect 1856 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1858 may also couple to the processor 1852 via the interconnect 1856. In an example, the storage 1858 may be implemented via a solid-state disk drive (SSDD). Other devices that may be used for the storage 1858 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1858 may be on-die memory or registers associated with the processor 1852. However, in some examples, the storage 1858 may be implemented using a micro hard disk drive (HDD). Further, any number of new technologies may be used for the storage 1858 in addition to, or instead of, the technologies described, such resistance change memories, phase change memories, holographic memories, or chemical memories, among others.

The components may communicate over the interconnect 1856. The interconnect 1856 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1856 may be a proprietary bus, for example, used in an SoC based system. Other bus systems may be included, such as an I2C interface, an SPI interface, point to point interfaces, and a power bus, among others.

The interconnect 1856 may couple the processor 1852 to a transceiver 1866, for communications with the connected edge devices 1862. The transceiver 1866 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1862. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1866 (or multiple transceivers) may communicate using multiple standards or radios for communications at a different range. For example, the edge computing node 1850 may communicate with close devices, e.g., within about 10 meters, using a local transceiver based on BLE, or another low power radio, to save power. More distant connected edge devices 1862, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1866 (e.g., a radio transceiver) may be included to communicate with devices or services in the edge cloud 1890 via local or wide area network protocols. The wireless network transceiver 1866 may be an LPWA transceiver that follows the IEEE 802.15.4, or IEEE 802.15.4g standards, among others. The edge computing node 1850 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1866, as described herein. For example, the transceiver 1866 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1866 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1868 may be included to provide a wired communication to nodes of the edge cloud 1890 or to other devices, such as the connected edge devices 1862 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1868 may be included to enable connecting to a second network, for example, a first NIC 1868 providing communications to the cloud over Ethernet, and a second NIC 1868 providing communications to other devices over another type of network.

Given the variety of types of applicable communications from the device to another component or network, applicable communications circuitry used by the device may include or be embodied by any one or more of components 1864, 1866, 1868, or 1870. Accordingly, in various examples, applicable means for communicating (e.g., receiving, transmitting, etc.) may be embodied by such communications circuitry.

The edge computing node 1850 may include or be coupled to acceleration circuitry 1864, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like.

The interconnect 1856 may couple the processor 1852 to a sensor hub or external interface 1870 that is used to connect additional devices or subsystems. The devices may include sensors 1872, such as accelerometers, level sensors, flow sensors, optical light sensors, camera sensors, temperature sensors, global navigation system (e.g., GPS) sensors, pressure sensors, barometric pressure sensors, and the like. The hub or interface 1870 further may be used to connect the edge computing node 1850 to actuators 1874, such as power switches, valve actuators, an audible sound generator, a visual warning device, and the like.

In some optional examples, various input/output (I/O) devices may be present within or connected to, the edge computing node 1850. For example, a display or other output device 1884 may be included to show information, such as sensor readings or actuator position. An input device 1886, such as a touch screen or keypad may be included to accept input. An output device 1884 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1850. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1876 may power the edge computing node 1850, although, in examples in which the edge computing node 1850 is mounted in a fixed location, it may have a power supply coupled to an electrical grid, or the battery may be used as a backup or for temporary capabilities. The battery 1876 may be a lithium ion battery, or a metal-air battery, such as a zinc-air battery, an aluminum-air battery, a lithium-air battery, and the like.

A battery monitor/charger 1878 may be included in the edge computing node 1850 to track the state of charge (SoCh) of the battery 1876, if included. The battery monitor/charger 1878 may be used to monitor other parameters of the battery 1876 to provide failure predictions, such as the state of health (SoH) and the state of function (SoF) of the battery 1876. The battery monitor/charger 1878 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1878 may communicate the information on the battery 1876 to the processor 1852 over the interconnect 1856. The battery monitor/charger 1878 may also include an analog-to-digital (ADC) converter that enables the processor 1852 to directly monitor the voltage of the battery 1876 or the current flow from the battery 1876. The battery parameters may be used to determine actions that the edge computing node 1850 may perform, such as transmission frequency, mesh network operation, sensing frequency, and the like.

A power block 1880, or other power supply coupled to a grid, may be coupled with the battery monitor/charger 1878 to charge the battery 1876. In some examples, the power block 1880 may be replaced with a wireless power receiver to obtain the power wirelessly, for example, through a loop antenna in the edge computing node 1850. A wireless battery charging circuit, such as an LTC4020 chip from Linear Technologies of Milpitas, Calif., among others, may be included in the battery monitor/charger 1878. The specific charging circuits may be selected based on the size of the battery 1876, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1858 may include instructions 1882 in the form of software, firmware, or hardware commands to implement the techniques described herein. Although such instructions 1882 are shown as code blocks included in the memory 1854 and the storage 1858, it may be understood that any of the code blocks may be replaced with hardwired circuits, for example, built into an application specific integrated circuit (ASIC).

In an example, the instructions 1882 provided via the memory 1854, the storage 1858, or the processor 1852 may be embodied as a non-transitory, machine-readable medium 1860 including code to direct the processor 1852 to perform electronic operations in the edge computing node 1850. The processor 1852 may access the non-transitory, machine-readable medium 1860 over the interconnect 1856. For instance, the non-transitory, machine-readable medium 1860 may be embodied by devices described for the storage 1858 or may include specific storage units such as optical disks, flash drives, or any number of other hardware devices. The non-transitory, machine-readable medium 1860 may include instructions to direct the processor 1852 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

From the foregoing, it will be appreciated that example methods, apparatus and articles of manufacture have been disclosed that reduce artifacts of certain modeling approaches and how such models can adversely affect a prediction accuracy. While traditional approaches to scheduling workloads rely upon a selected model (e.g., a model selected by virtue of analyst discretion), examples disclosed herein apply machine learning approaches to evaluate different types of models and their corresponding ability to predict an output with a corresponding degree of accuracy. Those models that exhibit a combinational improvement are retained with their corresponding attributes to predict which resources are consumed and which resources are idle, thereby allowing job assignments in a more efficient manner. As a result, revenue from clients is increased by allowing job service timeline expectations to be met with fewer expensive capital resources required to provide such job services.

Examples disclosed herein also improve machine learning training of models by generating different data matrices of target hardware resources. In particular, because example labelled data matrices generated herein include different combinations of target hardware details, one or more machine learning training operations have additional input variations for the learning process.

Examples disclosed herein also improve particular model efficiency by removing one or more layers of a model that do not substantially contribute to prediction efforts. In particular, some layers of a model do not exhibit the same likelihood of firing as other layers of that model. As such, in the event one or more layers of that model fail to satisfy a threshold probability of activating, then those particular layers contribute to computational inefficiencies when generating predictions. Accordingly, examples disclosed herein both discover such wasteful layers and remove them, thereby improving an operational and/or otherwise computational efficiency of that model.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods, apparatus, systems, and articles of manufacture to improve job scheduling efficiency are disclosed herein. Further examples and combinations thereof include the following:

Example 1 includes an apparatus to improve job resource scheduling efficiency, comprising a feature generator to import default values of features corresponding to a first model type, a label trainer to train labels corresponding to the first model type, and a model evaluator to determine an accuracy metric of the first model type based on a first prediction corresponding to the default features, and update the features from the default values to updated values when the accuracy metric does not satisfy an accuracy threshold.

Example 2 includes the apparatus as defined in example 1, wherein the model evaluator is to increase the accuracy metric of the first model type by increasing a degree feature of the first model type.

Example 3 includes the apparatus as defined in example 2, wherein the first model type is a polynomial regression model.

Example 4 includes the apparatus as defined in example 1, wherein the model evaluator is to set a polynomial activation weight to cause proportional utilization of the first model type and a second model type when generating predictions.

Example 5 includes the apparatus as defined in example 4, wherein the model evaluator is to set the polynomial activation weight to a first activation value corresponding to the default values of the features.

Example 6 includes the apparatus as defined in example 5, wherein the first activation value causes exclusive utilization of the first model type and prevention of utilization of the second model type.

Example 7 includes the apparatus as defined in example 4, further including a data retriever to determine whether historical data is available.

Example 8 includes the apparatus as defined in example 7, wherein the historical data corresponds to at least one of historical model training data or historical job-mapping data.

Example 9 includes the apparatus as defined in example 1, further including a model builder to calculate a sufficiency metric of historical data corresponding to prior job allocation instances to resources.

Example 10 includes the apparatus as defined in example 9, wherein the model builder is to set a polynomial activation weight based on the sufficiency metric.

Example 11 includes the apparatus as defined in example 10, wherein the polynomial activation weight causes the model evaluator to proportionally utilize the first model type and a second model type when generating predictions.

Example 12 includes the apparatus as defined in example 11, wherein the second model type is more computationally efficient than the first model type.

Example 13 includes the apparatus as defined in example 10, wherein the model builder is to set the polynomial activation weight to utilize a second model type more than the first model type when a proportional amount of the historical data increases.

Example 14 includes at least one non-transitory computer readable medium comprising instructions that, when executed, cause at least one processor to at least import default values of features corresponding to a first model type, train labels corresponding to the first model type, determine an accuracy metric of the first model type based on a first prediction corresponding to the default features, and update the features from the default values to updated values when the accuracy metric does not satisfy an accuracy threshold.

Example 15 includes the at least one computer readable medium as defined in example 14, wherein the instructions, when executed, cause the at least one processor to increase the accuracy metric of the first model type by increasing a degree feature of the first model type.

Example 16 includes the at least one computer readable medium as defined in example 14, wherein the instructions, when executed, cause the at least one processor to set a polynomial activation weight to cause proportional utilization of the first model type and a second model type when generating predictions.

Example 17 includes the at least one computer readable medium as defined in example 16, wherein the instructions, when executed, cause the at least one processor to set the polynomial activation weight to a first activation value corresponding to the default values of the features.

Example 18 includes the at least one computer readable medium as defined in example 17, wherein the instructions, when executed, cause the at least one processor to utilize the first model type exclusively, and prevent utilization of the second model type.

Example 19 includes the at least one computer readable medium as defined in example 16, wherein the instructions, when executed, cause the at least one processor to determine whether historical data is available.

Example 20 includes the at least one computer readable medium as defined in example 19, wherein the instructions, when executed, cause the at least one processor to identify the historical data as at least one of historical model training data or historical job-mapping data.

Example 21 includes the at least one computer readable medium as defined in example 14, wherein the instructions, when executed, cause the at least one processor to calculate a sufficiency metric of historical data corresponding to prior job allocation instances to resources.

Example 22 includes the at least one computer readable medium as defined in example 21, wherein the instructions, when executed, cause the at least one processor to set a polynomial activation weight based on the sufficiency metric.

Example 23 includes the at least one computer readable medium as defined in example 22, wherein the instructions, when executed, cause the at least one processor to proportionally utilize the first model type and a second model type when generating predictions.

Example 24 includes the at least one computer readable medium as defined in example 22, wherein the instructions, when executed, cause the at least one processor to set the polynomial activation weight to utilize a second model type more than the first model type when a proportional amount of the historical data increases.

Example 25 includes an apparatus to improve job resource scheduling efficiency, comprising means for generating features to import default values of features corresponding to a first model type, means for training labels to train labels corresponding to the first model type, and means for evaluating models to determine an accuracy metric of the first model type based on a first prediction corresponding to the default features, and update the features from the default values to updated values when the accuracy metric does not satisfy an accuracy threshold.

Example 26 includes the apparatus as defined in example 25, wherein the model evaluating means is to increase the accuracy metric of the first model type by increasing a degree feature of the first model type.

Example 27 includes the apparatus as defined in example 26, wherein the first model type is a polynomial regression model.

Example 28 includes the apparatus as defined in example 25, wherein the model evaluating means is to set a polynomial activation weight to cause proportional utilization of the first model type and a second model type when generating predictions.

Example 29 includes the apparatus as defined in example 28, wherein the model evaluating means is to set the polynomial activation weight to a first activation value corresponding to the default values of the features.

Example 30 includes the apparatus as defined in example 29, wherein the first activation value causes exclusive utilization of the first model type and prevention of utilization of the second model type.

Example 31 includes the apparatus as defined in example 28, further including means for retrieving data to determine whether historical data is available.

Example 32 includes the apparatus as defined in example 31, wherein the historical data corresponds to at least one of historical model training data or historical job-mapping data.

Example 33 includes the apparatus as defined in example 25, further including means for building models to calculate a sufficiency metric of historical data corresponding to prior job allocation instances to resources.

Example 34 includes the apparatus as defined in example 33, wherein the model building means is to set a polynomial activation weight based on the sufficiency metric.

Example 35 includes the apparatus as defined in example 34, wherein the model evaluating means is to proportionally utilize the first model type and a second model type based on the polynomial activation weight when generating predictions.

Example 36 includes the apparatus as defined in example 35, wherein the second model type is more computationally efficient than the first model type.

Example 37 includes the apparatus as defined in example 34, wherein the model building means is to set the polynomial activation weight to utilize a second model type more than the first model type when a proportional amount of the historical data increases.

Example 38 includes a computer-implemented method to improve job resource scheduling efficiency, comprising importing, by executing an instruction with at least one processor, default values of features corresponding to a first model type, training, by executing an instruction with the at least one processor, labels corresponding to the first model type, determining, by executing an instruction with the at least one processor, an accuracy metric of the first model type based on a first prediction corresponding to the default features, and updating, by executing an instruction with the at least one processor, the features from the default values to updated values when the accuracy metric does not satisfy an accuracy threshold.

Example 39 includes the method as defined in example 38, further including increasing the accuracy metric of the first model type by increasing a degree feature of the first model type.

Example 40 includes the method as defined in example 38, further including setting a polynomial activation weight to cause proportional utilization of the first model type and a second model type when generating predictions.

Example 41 includes the method as defined in example 40, further including setting the polynomial activation weight to a first activation value corresponding to the default values of the features.

Example 42 includes the method as defined in example 41, further including utilizing the first model type exclusively, and prevent utilization of the second model type.

Example 43 includes the method as defined in example 40, further including determining whether historical data is available.

Example 44 includes the method as defined in example 43, further including identifying the historical data as at least one of historical model training data or historical job-mapping data.

Example 45 includes the method as defined in example 38, further including calculating a sufficiency metric of historical data corresponding to prior job allocation instances to resources.

Example 46 includes the method as defined in example 45, further including setting a polynomial activation weight based on the sufficiency metric.

Example 47 includes the method as defined in example 46, further including proportionally utilizing the first model type and a second model type when generating predictions.

Example 48 includes the method as defined in example 46, further including setting the polynomial activation weight to utilize a second model type more than the first model type when a proportional amount of the historical data increases.

Example 49 includes an apparatus to generate labelled training data for a job scheduling system, comprising a model evaluator to import a first set of attributes corresponding to computing resources of the job scheduling system, determine whether the first set of attributes has previously been used to train a model of interest, and in response to determining that the first set of attributes has not been used to train the model of interest, train the model of interest based on a training threshold.

Example 50 includes the apparatus as defined in example 49, wherein the training threshold includes at least one of a threshold number of training iterations of the model of interest, a threshold duration of time when training the model of interest, or a threshold number of training epochs.

Example 51 includes the apparatus as defined in example 49, wherein the first set of attributes includes at least one of a number of boards running a first job type, a number of jobs currently running, or a number of jobs waiting.

Example 52 includes the apparatus as defined in example 49, wherein the model evaluator is to select a second set of attributes in response to determining the first set of attributes has been used to train the model of interest, the first set of attributes different than the second set of attributes.

Example 53 includes the apparatus as defined in example 49, further including an architecture analyzer to determine the first set of attributes by analyzing communicatively connected hardware resources of the scheduling system.

Example 54 includes the apparatus as defined in example 53, wherein the architecture analyzer is to determine at least one of a number of servers of the connected hardware resources, a number of units within the number of servers, or a number of boards within the number of units.

Example 55 includes the apparatus as defined in example 49, further including a matrix generator to label respective ones of the first set of attributes based on a use status or a locked status.

Example 56 includes the apparatus as defined in example 55, wherein the matrix generator is to generate a matrix of labelled status indicators corresponding to the hardware resources.

Example 57 includes at least one non-transitory computer readable medium comprising instructions that, when executed, cause at least one processor to at least import a first set of attributes corresponding to computing resources of the job scheduling system, determine whether the first set of attributes has previously been used to train a model of interest, and in response to determining that the first set of attributes has not been used to train the model of interest, train the model of interest based on a training threshold.

Example 58 includes the at least one computer readable medium as defined in example 57, wherein the instructions, when executed, cause the at least one processor to identify the training threshold as at least one of a threshold number of training iterations of the model of interest, a threshold duration of time when training the model of interest, or a threshold number of training epochs.

Example 59 includes the at least one computer readable medium as defined in example 57, wherein the instructions, when executed, cause the at least one processor to identify the first set of attributes as at least one of a number of boards running a first job type, a number of jobs currently running, or a number of jobs waiting.

Example 60 includes the at least one computer readable medium as defined in example 57, wherein the instructions, when executed, cause the at least one processor to select a second set of attributes in response to determining the first set of attributes has been used to train the model of interest, the first set of attributes different than the second set of attributes.

Example 61 includes the at least one computer readable medium as defined in example 57, wherein the instructions, when executed, cause the at least one processor to determine the first set of attributes by analyzing communicatively connected hardware resources of the scheduling system.

Example 62 includes the at least one computer readable medium as defined in example 61, wherein the instructions, when executed, cause the at least one processor to determine at least one of a number of servers of the connected hardware resources, a number of units within the number of servers, or a number of boards within the number of units.

Example 63 includes the at least one computer readable medium as defined in example 57, wherein the instructions, when executed, cause the at least one processor to label respective ones of the first set of attributes based on a use status or a locked status.

Example 64 includes the at least one computer readable medium as defined in example 63, wherein the instructions, when executed, cause the at least one processor to generate a matrix of labelled status indicators corresponding to the hardware resources.

Example 65 includes an apparatus to generate labelled training data for a job scheduling system, comprising means for analyzing architecture to determine a first set of attributes by analyzing communicatively connected hardware resources of the job scheduling system, and means for model evaluating to import the first set of attributes corresponding to the hardware resources of the job scheduling system, determine whether the first set of attributes has previously been used to train a model of interest, and in response to determining that the first set of attributes has not been used to train the model of interest, train the model of interest based on a training threshold.

Example 66 includes the apparatus as defined in example 65, wherein the training threshold includes at least one of a threshold number of training iterations of the model of interest, a threshold duration of time when training the model of interest, or a threshold number of training epochs.

Example 67 includes the apparatus as defined in example 65, wherein the first set of attributes includes at least one of a number of boards running a first job type, a number of jobs currently running, or a number of jobs waiting.

Example 68 includes the apparatus as defined in example 65, wherein the model evaluating means is to select a second set of attributes in response to determining the first set of attributes has been used to train the model of interest, the first set of attributes different than the second set of attributes.

Example 69 includes the apparatus as defined in example 65, wherein the architecture analyzing means is to determine at least one of a number of servers of the connected hardware resources, a number of units within the number of servers, or a number of boards within the number of units.

Example 70 includes the apparatus as defined in example 65, further including means for matrix generating to label respective ones of the first set of attributes based on a use status or a locked status.

Example 71 includes the apparatus as defined in example 70, wherein the matrix generating means is to generate a matrix of labelled status indicators corresponding to the hardware resources.

Example 72 includes a method to generate labelled training data for a job scheduling system, comprising importing, by executing an instruction with at least one processor, a first set of attributes corresponding to computing resources of the job scheduling system, determining, by executing an instruction with the at least one processor, whether the first set of attributes has previously been used to train a model of interest, and in response to determining that the first set of attributes has not been used to train the model of interest, training, by executing an instruction with the at least one processor, the model of interest based on a training threshold.

Example 73 includes the method as defined in example 72, further including identifying the training threshold as at least one of a threshold number of training iterations of the model of interest, a threshold duration of time when training the model of interest, or a threshold number of training epochs.

Example 74 includes the method as defined in example 72, further including identifying the first set of attributes as at least one of a number of boards running a first job type, a number of jobs currently running, or a number of jobs waiting.

Example 75 includes the method as defined in example 72, further including selecting a second set of attributes in response to determining the first set of attributes has been used to train the model of interest, the first set of attributes different than the second set of attributes.

Example 76 includes the method as defined in example 72, further including determining the first set of attributes by analyzing communicatively connected hardware resources of the scheduling system.

Example 77 includes the method as defined in example 76, further including determining at least one of a number of servers of the connected hardware resources, a number of units within the number of servers, or a number of boards within the number of units.

Example 78 includes the method as defined in example 72, further including labelling respective ones of the first set of attributes based on a use status or a locked status.

Example 79 includes the method as defined in example 78, further including generating a matrix of labelled status indicators corresponding to the hardware resources.

Example 80 includes an apparatus to improve model efficiency, comprising a model state assessor to select a model of interest, select a layer within the model of interest, calculate a probability value corresponding to the layer, compare the probability value to a cull threshold, and improve an efficiency of the model by removing the layer from the model when the probability value satisfies the cull threshold.

Example 81 includes the apparatus as defined in example 80, wherein the model state assessor is to retain the layer when the probability value does not satisfy the cull threshold.

Example 82 includes the apparatus as defined in example 80, wherein the model state assessor is to select a second layer for evaluation after the layer probability value is calculated.

Example 83 includes the apparatus as defined in example 80, wherein the model includes a long short-term memory (LSTM) model.

Example 84 includes a non-transitory computer readable medium comprising instructions that, when executed, cause at least one processor to at least select a model of interest, select a layer within the model of interest, calculate a probability value corresponding to the layer, compare the probability value to a cull threshold, and improve an efficiency of the model by removing the layer from the model when the probability value satisfies the cull threshold.

Example 85 includes the computer readable medium as defined in example 84, wherein the instructions, when executed, cause the at least one processor to retain the layer when the probability value does not satisfy the cull threshold.

Example 86 includes the computer readable medium as defined in example 84, wherein the instructions, when executed, cause the at least one processor to select a second layer for evaluation after the layer probability value is calculated.

Example 87 includes the computer readable medium as defined in example 84, wherein the instructions, when executed, cause the at least one processor to implement the model as a long short-term memory (LSTM) model.

Example 88 includes an apparatus to improve model efficiency, comprising means for retrieving to retrieve data corresponding to available models, and means for model state assessing to select a model of interest, select a layer within the model of interest, calculate a probability value corresponding to the layer, compare the probability value to a cull threshold, and improve an efficiency of the model by removing the layer from the model when the probability value satisfies the cull threshold.

Example 89 includes the apparatus as defined in example 88, wherein the model state assessing means is to retain the layer when the probability value does not satisfy the cull threshold.

Example 90 includes the apparatus as defined in example 88, wherein the model state assessing means is to select a second layer for evaluation after the layer probability value is calculated.

Example 91 includes the apparatus as defined in example 88, wherein the model state assessing means is to implement the model as a long short-term memory (LSTM) model.

Example 92 includes a method to improve model efficiency, comprising selecting, by executing an instruction with at least one processor, a model of interest, selecting, by executing an instruction with the at least one processor, a layer within the model of interest, calculating, by executing an instruction with the at least one processor, a probability value corresponding to the layer, comparing, by executing an instruction with the at least one processor, the probability value to a cull threshold, and improving, by executing an instruction with the at least one processor, an efficiency of the model by removing the layer from the model when the probability value satisfies the cull threshold.

Example 93 includes the method as defined in example 92, further including retaining the layer when the probability value does not satisfy the cull threshold.

Example 94 includes the method as defined in example 92, further including selecting a second layer for evaluation after the layer probability value is calculated.

Example 95 includes the method as defined in example 92, further including implementing the model as a long short-term memory (LSTM) model.

Example 96 is a computer-readable medium comprising instructions to perform any of Examples 38-48.

Example 97 is a computer-readable medium comprising instructions to perform any of Examples 72-79.

Example 98 is a computer-readable medium comprising instructions to perform any of Examples 92-95.

Example 99 is an edge computing gateway, comprising processing circuitry to perform any of Examples 38-48.

Example 100 is an edge computing gateway, comprising processing circuitry to perform any of Examples 72-79.

Example 101 is an edge computing gateway, comprising processing circuitry to perform any of Examples 92-95.

Example 102 includes any of Examples 1-13, wherein job requests include metadata corresponding to at least one of job priority information, job type information, or hardware requirements information.

Example 103 includes any of Examples 1-13, further including assigning a job request to at least one resource based on at least one of a smallest-best-fit optimization algorithm, a largest-best-fit optimization algorithm, or a knapsack optimization algorithm.

In Example 104, the subject matter of any of Examples 1-13 optionally includes a satellite-based connection to the Internet.

Example 105 includes any of Examples 1-13, further including applying Bayesian analysis to generate model certainty metrics.

Example 106 includes any of Examples 49-56, wherein the computing resources include at least one of servers or edge-located devices.

Example 107 includes any of Examples 49-56, wherein the model of interest includes at least one of a polynomial regression model or a long short-term memory (LSTM) model.

Example 108 includes any of Examples 1-13, wherein improving the job resource scheduling efficiency is caused by assessing risk reduction, assessing accuracy and certainty of the first model type, assessing slack of future job schedules, and assessing internal states of the first model type.

Example 109 includes any of Examples 14-24, wherein improving the job resource scheduling efficiency is caused by assessing risk reduction, assessing accuracy and certainty of the first model type, assessing slack of future job schedules, and assessing internal states of the first model type.

Example 110 includes any of Examples 25-37, wherein improving the job resource scheduling efficiency is caused by assessing risk reduction, assessing accuracy and certainty of the first model type, assessing slack of future job schedules, and assessing internal states of the first model type.

Example 111 includes any of Examples 38-48, wherein improving the job resource scheduling efficiency is caused by assessing risk reduction, assessing accuracy and certainty of the first model type, assessing slack of future job schedules, and assessing internal states of the first model type.

The following claims are hereby incorporated into this Detailed Description by this reference, with each claim standing on its own as a separate embodiment of the present disclosure.

1. An apparatus to improve job resource scheduling efficiency, comprising:
at least one memory;
instructions; and
at least one processor to instantiate:
a feature generator to import default values of features corresponding to a first model type;
a label trainer to train labels corresponding to the first model type; and
a model evaluator to:
determine an accuracy metric of the first model type based on a first prediction corresponding to the default features; and
update the features from the default values to updated values when the accuracy metric does not satisfy an accuracy threshold.

2. The apparatus as defined in claim 1, wherein the model evaluator is to increase the accuracy metric of the first model type by increasing a degree feature of the first model type.

3. The apparatus as defined in claim 2, wherein the first model type is a polynomial regression model.

4. The apparatus as defined in claim 1, wherein the model evaluator is to set a polynomial activation weight to cause proportional utilization of the first model type and a second model type when generating predictions.

5. The apparatus as defined in claim 4, wherein the model evaluator is to set the polynomial activation weight to a first activation value corresponding to the default values of the features.

6. The apparatus as defined in claim 5, wherein the first activation value causes exclusive utilization of the first model type and prevention of utilization of the second model type.

7. (canceled)

8. (canceled)

9. The apparatus as defined in claim 1, further including a model builder to calculate a sufficiency metric of historical data corresponding to prior job allocation instances to resources.

10. The apparatus as defined in claim 9, wherein the model builder is to set a polynomial activation weight based on the sufficiency metric.

11-13. (canceled)

14. At least one non-transitory computer readable medium comprising instructions that, when executed, cause at least one processor to at least:
import default values of features corresponding to a first model type;
train labels corresponding to the first model type;
determine an accuracy metric of the first model type based on a first prediction corresponding to the default features; and
update the features from the default values to updated values when the accuracy metric does not satisfy an accuracy threshold.

15. The at least one computer readable medium as defined in claim 14, wherein the instructions, when executed, cause the at least one processor to increase the accuracy metric of the first model type by increasing a degree feature of the first model type.

16. The at least one computer readable medium as defined in claim 14, wherein the instructions, when executed, cause the at least one processor to set a polynomial activation weight to cause proportional utilization of the first model type and a second model type when generating predictions.

17. The at least one computer readable medium as defined in claim 16, wherein the instructions, when executed, cause the at least one processor to set the polynomial activation weight to a first activation value corresponding to the default values of the features.

18. The at least one computer readable medium as defined in claim 17, wherein the instructions, when executed, cause the at least one processor to utilize the first model type exclusively, and prevent utilization of the second model type.

19. The at least one computer readable medium as defined in claim 16, wherein the instructions, when executed, cause the at least one processor to determine whether historical data is available.

20. The at least one computer readable medium as defined in claim 19, wherein the instructions, when executed, cause the at least one processor to identify the historical data as at least one of historical model training data or historical job-mapping data.

21. The at least one computer readable medium as defined in claim 14, wherein the instructions, when executed, cause the at least one processor to calculate a sufficiency metric of historical data corresponding to prior job allocation instances to resources.

22. The at least one computer readable medium as defined in claim 21, wherein the instructions, when executed, cause the at least one processor to set a polynomial activation weight based on the sufficiency metric.

23. (canceled)

24. (canceled)

25. An apparatus to improve job resource scheduling efficiency, comprising:
means for generating features to import default values of features corresponding to a first model type;
means for training labels to train labels corresponding to the first model type; and
means for evaluating models to:
determine an accuracy metric of the first model type based on a first prediction corresponding to the default features; and
update the features from the default values to updated values when the accuracy metric does not satisfy an accuracy threshold.

26. The apparatus as defined in claim 25, wherein the model evaluating means is to increase the accuracy metric of the first model type by increasing a degree feature of the first model type.

27. The apparatus as defined in claim 26, wherein the first model type is a polynomial regression model.

28. The apparatus as defined in claim 25, wherein the model evaluating means is to set a polynomial activation weight to cause proportional utilization of the first model type and a second model type when generating predictions.

29. The apparatus as defined in claim 28, wherein the model evaluating means is to set the polynomial activation weight to a first activation value corresponding to the default values of the features.

30. The apparatus as defined in claim 29, wherein the first activation value causes exclusive utilization of the first model type and prevention of utilization of the second model type.

31. The apparatus as defined in claim 28, further including means for retrieving data to determine whether historical data is available.

32. The apparatus as defined in claim 31, wherein the historical data corresponds to at least one of historical model training data or historical job-mapping data.

33-95. (canceled)
